(19) United States
(12) Patent Application Publication
(10) Pub. No.: US 2018/0278947 A1
(43) Pub. Date: Sep. 27, 2018

(54) DISPLAY DEVICE, COMMUNICATION DEVICE, METHOD OF CONTROLLING DISPLAY DEVICE, AND METHOD OF CONTROLLING COMMUNICATION DEVICE

(71) Applicant: SEIKO EPSON CORPORATION, Tokyo (JP)

(72) Inventors: Hiroyuki HASHIMOTO, Hara-Mura (JP); Kazuki NAGAI, Azumino-Shi (JP)

(73) Assignee: SEIKO EPSON CORPORATION, Tokyo (JP)

(21) Appl. No.: 15/928,419

(22) Filed: Mar. 22, 2018

(30) Foreign Application Priority Data
Mar. 24, 2017 (JP) 2017-058471
Mar. 28, 2017 (JP) 2017-063170

(51) Int. Cl. H04N 19/44; H04N 19/50

(52) U.S. Cl. CPC H04N 19/44; G06F 3/14; H04N 19/50

(57) ABSTRACT

A display device includes an extraction section adapted to extract a first reference frame coded by intra-frame compression from a first image stream, and extract a second reference frame coded by the intra-frame compression from a second image stream, a generation section adapted to generate a composite image stream using the first reference frame and the second reference frame, a decoder adapted to decode the composite image stream to generate image frames by a frame included in the composite image stream, and a display section adapted to display an image corresponding to the image frame on a display surface.

### BACKGROUND

### 1. Technical Field

The present invention relates to a display device, a communication device, a method of controlling the display device, and a method of controlling the communication device.

### 2. Related Art

As a technology for transmitting an image stream with wireless communication, there is known Miracast (registered trademark). In existing Miracast, a source and a sink perform wireless communication on a one-to-one basis. The source transmits a single image stream formed of a plurality of coded frames to the sink. The sink decodes the single image stream having been received from the source with a single decoder to generate a plurality of image frames.

Further, in JP-A-2013-167769 (Document 1), there is described an image projection device for displaying a plurality of images based on a plurality of input data.

Due to an extension of the standard of Miracast, it becomes possible for the sink to achieve concurrent connection to a plurality of sources. Therefore, it becomes possible for the sink to receive the plurality of image streams in parallel with each other. Therefore, it can be expected to display the plurality of images based on the plurality of input data (the plurality of image streams) also in the sink as in the image projection device described in Document 1.

Incidentally, in the configuration of displaying the plurality of images based on the plurality of image streams, it is conceivable to dispose decoders for decoding the image stream respectively for the image streams. However, in this case, it becomes necessary to provide the same number of decoders as the number of image streams, and thus, the number of decoders increases.

### SUMMARY

An advantage of some aspects of the invention is to provide a technology capable of suppressing an increase in the number of decoders in the configuration of displaying a plurality of images based on a plurality of image streams.

A display device according to an aspect of the invention includes an extraction section adapted to extract a first reference frame coded by intra-frame compression from a first image stream, and extract a second reference frame coded by the intra-frame compression from a second image stream, a generation section adapted to generate a composite image stream using the first reference frame and the second reference frame, a decoder adapted to decode the composite image stream to generate image frames by a frame included in the composite image stream, and a display section adapted to display an image corresponding to the image frame on a display surface.

According to the aspect of the invention, it becomes possible to prevent the number of the decoders from increasing in the configuration of displaying the plurality of images based on the plurality of image streams.

It is desirable that the display device according to the aspect of the invention described above further includes a communication section adapted to receive the first image stream and the second image stream, and an addition section adapted to append first identification information corresponding to a transmission source of the first image stream to the first reference frame, and append second identification information corresponding to a transmission source of the second image stream to the second reference frame, in the image frames, a first image frame generated based on the first reference frame has the first identification information, in the image frames, a second image frame generated based on the second reference frame has the second identification information, and the display section displays an image corresponding to the first image frame in a display area corresponding to the first identification information, and displays an image corresponding to the second image frame in a display area corresponding to the second identification information.

According to the aspect of the invention with this configuration, it becomes possible to display the images corresponding to the image streams at respective display positions different from each other for the respective image streams. Therefore, it becomes possible for the user to simultaneously look at the outlines of the images corresponding respectively to the two image streams received in parallel with each other.

In the display device according to the aspect of the invention described above, it is desirable that the first reference frame and the second reference frame have timing information representing a display timing with a value of a numerical number with a plurality of digits, the larger the value of the numerical number is, the later the display timing becomes, and the addition section sets the first identification information to a specific digit different from a most significant digit out of the plurality of digits of the timing information the first reference frame has, and sets the second identification information to the specific digit out of the plurality of digits of the timing information the second reference frame has.

According to the aspect of the invention with this configuration, a part of the numerical number with a plurality of digits representing the display timing is also used as the identification information. Therefore, it is possible to reduce the information amount compared to the configuration of newly using dedicated identification information. Further, since the identification information is set to a different digit from the most significant digit of the numerical number representing the display timing, the shift in display timing can be reduced compared to the configuration of setting the identification information to the most significant digit of the numerical number.

In the display device according to the aspect of the invention described above, it is desirable that the specific digit includes a least significant digit without including a most significant digit out of the plurality of digits.

The least significant digit of the numerical number representing the display timing has the smallest influence on the shift of the display timing out of the digits of the numerical number. Therefore, according to the aspect of the invention with this configuration, it becomes possible to reduce the shift of the display timing due to the setting of the identification information to the numerical number representing the display timing.

In the display device according to the aspect of the invention described above, it is desirable that the communication section further designates resolution of an image stream to a transmission source of the first image stream and a transmission source of the second image stream.

The higher the resolution of the image stream is, the larger the data amount of the image stream becomes, and the smaller the room of the transmission band of the image stream becomes. According to the aspect of the invention with this configuration, it becomes possible to control the room of the transmission band of the image stream.

In the display device according to the aspect of the invention described above, it is desirable that in a case in which the display section displays the image corresponding to the first image frame and the image corresponding to the second image frame, the communication section designates first resolution to a transmission source of the first image stream and a transmission source of the second image stream, and in a case in which the display section displays the image corresponding to the first image frame without displaying the image corresponding to the second image frame, the communication section designates second resolution different from the first resolution to the transmission source of the first image stream.

According to the aspect of the invention with this configuration, it becomes possible to change the resolution of the image corresponding to the first image frame in accordance with whether or not the image corresponding to the second image frame is displayed together with the image corresponding to the first image frame.

A method of controlling a display device according to an aspect of the invention includes extracting a first reference frame coded by intra-frame compression from a first image stream, extracting a second reference frame coded by the intra-frame compression from a second image stream, generating a composite image stream using the first reference frame and the second reference frame, decoding the composite image stream to generate image frames by a frame included in the composite image stream, and displaying an image corresponding to the image frame.

According to the aspect of the invention, it becomes possible to prevent the number of the decoders from increasing in the configuration of displaying the plurality of images based on the plurality of image streams.

A display device according to an aspect of the invention includes a generation section adapted to generate a third image stream using a first image stream having a first frame coded by intra-frame compression, and a second image stream having a second frame coded by the intra-frame compression, a decoder adapted to decode the third image stream to generate image frames by a frame included in the third image stream, and a display control section adapted to control display of an image corresponding to the image frame, the third image stream is an image stream obtained by inserting the second frame between the first frame and a third frame subsequent to the first frame, and further inserting a copy of the first frame previous to the third frame in the first image stream, and the decoder decodes at least one frame previous to the second frame in the third image stream at a second frame rate higher than a first frame rate specified in the first image stream, and the copy of the first frame and the second frame within a difference in time between decode time in a case of decoding at least one frame at the first frame rate and decode time in a case of decoding at least one frame at the second frame rate.

According to the aspect of the invention, it becomes possible to prevent the number of the decoders from increasing in the configuration of displaying the plurality of images based on the plurality of image streams.

In the display device according to the aspect of the invention described above, it is desirable that there is further included a communication section adapted to receive the first image stream and the second image stream, the generation section appends identification information corresponding to a transmission source of the second frame to the second frame, the image frame generated based on the second frame has the identification information, and the display control section displays an image corresponding to the image frame having the identification information in a different area from an area of an image corresponding to the image frame not having the identification information.

According to the aspect of the invention with this configuration, it becomes possible to display the images corresponding to the image streams at respective display positions different from each other for the respective image streams. Therefore, it becomes possible for the user to simultaneously look at at least the outlines of the images corresponding respectively to the first and second image streams received in parallel with each other.

In the display device according to the aspect of the invention described above, it is desirable that the image frame generated based on the second frame has timing information representing a display timing with a value of a numerical number with a plurality of digits, the larger the value of the numerical number is, the later the display timing becomes, and the generation section sets the identification information to a specific digit out of the plurality of digits.

According to the aspect of the invention with this configuration, a part of the numerical number with a plurality of digits representing the display timing is also used as the identification information. Therefore, it is possible to reduce the information amount compared to the configuration of newly using dedicated identification information.

A method of controlling a display device according to an aspect of the invention includes generating a third image stream using a first image stream having a first frame coded by intra-frame compression, and a second image stream having a second frame coded by the intra-frame compression, decoding the third image stream to generate image frames by a frame included in the third image stream, and controlling display of an image corresponding to the image frame, the third image stream is an image stream obtained by inserting the second frame between the first frame and a third frame subsequent to the first frame, and further inserting a copy of the first frame previous to the third frame in the first image stream, and in the decoding the third image stream, at least one frame previous to the second frame in the third image stream is decoded at a second frame rate higher than a first frame rate specified in the first image stream, and the copy of the first frame and the second frame are decoded within a difference in time between decode time in a case of decoding at least one frame at the first frame rate and decode time in a case of decoding at least one frame at the second frame rate.

According to the aspect of the invention, it becomes possible to prevent the number of the decoders from increasing in the configuration of displaying the plurality of images based on the plurality of image streams.

A communication device according to an aspect of the invention includes an extraction section adapted to extract a first reference frame coded by intra-frame compression from a first image stream, and extract a second reference frame coded by the intra-frame compression from a second image stream, a generation section adapted to generate a composite image stream using the first reference frame and the second reference frame, and a communication section adapted to transmit the composite image stream to a display device.

According to the aspect of the invention, it becomes possible for the display device to display a plurality of images without increasing the number of the decoders by receiving the composite image stream transmitted by the communication device, and then displaying the plurality of images based on the composite image stream.

A method of controlling a communication device according to an aspect of the invention includes extracting a first reference frame coded by intra-frame compression from a first image stream, extracting a second reference frame coded by the intra-frame compression from a second image stream, generating a composite image stream using the first reference frame and the second reference frame, and transmitting the composite image stream to a display device.

According to the aspect of the invention, it becomes possible for the display device to display a plurality of images without increasing the number of the decoders by receiving the composite image stream transmitted by the communication device, and then displaying the plurality of images based on the composite image stream.

A communication device according to an aspect of the invention includes a generation section adapted to generate a third image stream using a first image stream having a first frame coded by intra-frame compression, and a second image stream having a second frame coded by the intra-frame compression, and a communication section adapted to transmit the third image stream and an instruction related to decoding of the third image stream to a display device, the third image stream is an image stream obtained by inserting the second frame between the first frame and a third frame subsequent to the first frame, and further inserting a copy of the first frame previous to the third frame in the first image stream, and the instruction instructs to decode at least one frame previous to the second frame in the third image stream at a second frame rate higher than a first frame rate specified in the first image stream, and the copy of the first frame and the second frame within a difference in time between decode time in a case of decoding at least one frame at the first frame rate and decode time in a case of decoding at least one frame at the second frame rate.

According to the aspect of the invention, it becomes possible for the display device to display a plurality of images without increasing the number of the decoders by receiving the composite image stream and the instruction transmitted by the communication device, and then decoding the composite image stream in accordance with the instruction to display the plurality of images.

A method of controlling a communication device according to an aspect of the invention includes generating a third image stream using a first image stream having a first frame coded by intra-frame compression, and a second image stream having a second frame coded by the intra-frame compression, and transmitting the third image stream and an instruction related to decoding of the third image stream to a display device, the third image stream is an image stream obtained by inserting the second frame between the first frame and a third frame subsequent to the first frame, and further inserting a copy of the first frame previous to the third frame in the first image stream, and the instruction instructs to decode at least one frame previous to the second frame in the third image stream at a second frame rate higher than a first frame rate specified in the first image stream, and the copy of the first frame and the second frame within a difference in time between decode time in a case of decoding at least one frame at the first frame rate and decode time in a case of decoding at least one frame at the second frame rate.

According to the aspect of the invention, it becomes possible for the display device to display a plurality of images without increasing the number of the decoders by receiving the composite image stream and the instruction transmitted by the communication device, and then decoding the composite image stream in accordance with the instruction to display the plurality of images.

### BRIEF DESCRIPTION OF THE DRAWINGS

The invention will be described with reference to the accompanying drawings, wherein like numbers reference like elements.

FIG. 1 is a diagram showing a projector 1 according to a first embodiment to which the invention is applied.

FIG. 2 is a diagram schematically showing the projector 1.

FIG. 3 is a diagram showing an example of an image memory 113.

FIG. 4 is a diagram showing an example of a projection section 107.

FIG. 5 is a flowchart for explaining an operation of the projector 1.

FIG. 6 is a diagram for explaining a communication operation of the projector 1 and sources 21 through 24.

FIG. 7 is a diagram for explaining the communication operation of the projector 1 and the sources 21 through 24.

FIG. 8 is a diagram for explaining the communication operation of the projector 1 and the sources 21 through 24.

FIG. 9 is a diagram showing an example of setting identification information to the least significant digit of PTS.

FIG. 10 is a diagram for explaining the communication operation of the projector 1 and the sources 21 through 24.

FIG. 11 is a diagram for explaining an example in which thumbnails are switched in a single display area.

FIG. 12 is a diagram showing a projector 1A related to a display device according to a second embodiment of the invention.

FIG. 13 is a diagram schematically showing the projector 1A.

FIG. 14 is a diagram showing an example of an image memory 110A.

FIG. 15 is a flowchart for explaining an operation of the projector 1A.

FIG. 16 is a diagram for explaining the operation of the projector 1A.

FIG. 17 is a diagram for explaining the operation of the projector 1A.

FIG. 18 is a diagram for explaining the operation of the projector 1A.

FIG. 19 is a diagram for explaining a method for generating a composite image stream 100.

FIG. 20 is a diagram showing an example of the composite image stream 100.

FIG. 21 is a diagram for explaining control of a DTS of the composite image stream 100.

FIG. 22 is a diagram showing an example of a projection image 30A in the case in which the projector 1A receives image streams respectively from four image output devices in parallel with each other.

FIG. 23 is a diagram showing an example of a projector system according to Modified Example 18.

FIG. 24 is a diagram schematically showing a communication device 4A.

FIG. 25 is a diagram schematically showing a projector 1B.

FIG. 26 is a diagram showing an example of a projector system according to Modified Example 19.

FIG. 27 is a diagram schematically showing a communication device 4B.

### DESCRIPTION OF EXEMPLARY EMBODIMENTS

Hereinafter, some embodiments of the invention will be described with reference to the accompanying drawings. It should be noted that in the drawings, the size and the scale of each of the constituents are appropriately different from actual ones. Further, the embodiments described hereinafter are each a preferred specific example of the invention. Therefore, the present embodiments are provided with a variety of technically preferable limitations. However, the scope or the spirit of the invention is not limited to these embodiments unless there is any particular description of limiting the invention in the following description.

### First Embodiment

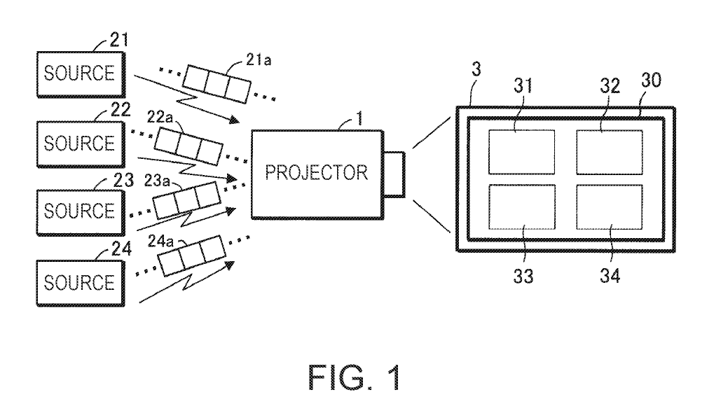

FIG. 1 is a diagram showing a projector 1 related to a display device according to a first embodiment to which the invention is applied. The projector 1 has a sink function of Miracast. The projector 1 achieves concurrent connection with a plurality of sources 21 through 24 of Miracast with wireless communication. It should be noted that the number of sources with which the projector 1 achieves the concurrent connection is not limited to 4, and is only required to be equal to or larger than 2.

The sources 21 through 24 are each, for example, a smartphone or a tablet terminal. It should be noted that the sources 21 through 24 are not limited to the smartphones or the tablet terminals, and are only required to have a source function of Miracast.

The sources 21 through 24 each wirelessly transmit an image stream (a moving image) formed of a plurality of coded frames to the projector 1 with an UDP (user datagram protocol) datagram. Further, the sources 21 through 24 each wirelessly transmit PCR (program clock reference), which is time information to be the reference of display (reproduction) timing, to the projector 1.

Hereinafter, the image stream transmitted by the source 21 is also referred to as an “image stream 21a.” Further, the image streams transmitted by the sources 22, 23, and 24 are also referred to as an “image stream 22a,” an “image stream 23a,” and an “image stream 24a,” respectively. The image stream 21a is an example of a first image stream. The image stream 22a is an example of a second image stream. The image streams 21a, 22a, 23a, and 24a are an example of a plurality of image streams.

The image stream can include three types of frames, namely an I frame (intra coded frame), a P frame (predicted frame), and a B frame (bidirectional predicted frame).

The I frame is an example of a reference frame. The I frame is a frame coded by intra-frame compression. Furthermore, the I frame is a frame which can be decoded alone without referring to other frames. The I frame is included in either of the image streams 21a, 22a, 23a, and 24a. The I frame included in the image stream 21a is an example of a first reference frame. The I frame included in the image stream 22a is an example of a second reference frame.

The P frame and the B frame are frames coded by inter-frame compression. Specifically, the P frame is a frame coded by the inter-frame compression using a previous frame in terms of time. The B frame is a frame coded by the inter-frame compression using previous and subsequent frames in terms of time.

The I frame, the P frame, and the B frame each have a PTS (presentation time stamp). The PTS represents the display timing of the frame with reference to the PCR with a value of a numerical number with a plurality of digits. The larger the numerical value represented by the PTS is, the later the display timing becomes. The PTS is an example of the timing information.

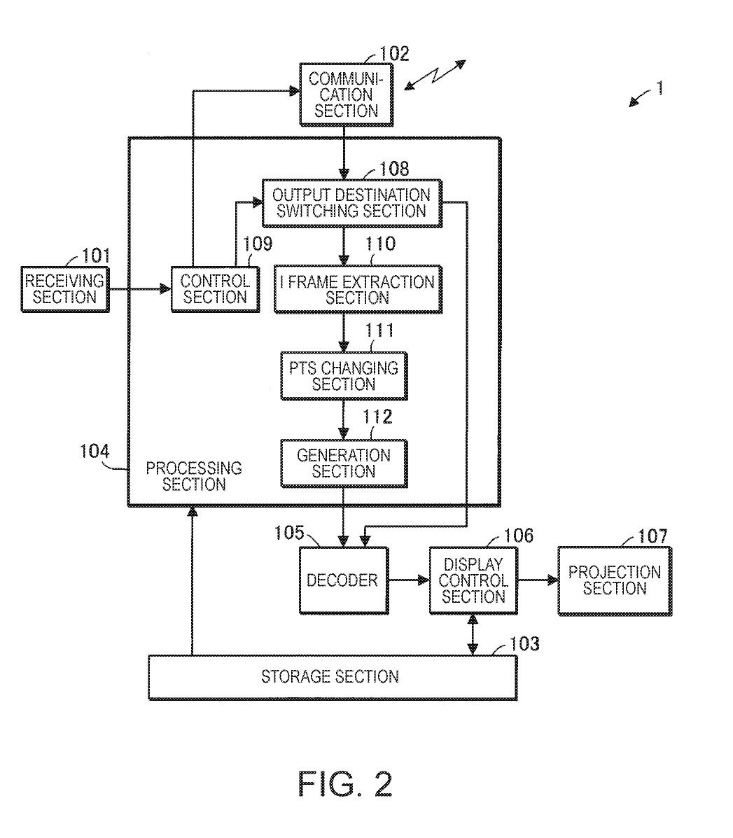

The projector 1 receives the image streams 21a, 22a, 23a, and 24a in parallel with each other. The projector 1 extracts the I frame from each of the image streams 21a, 22a, 23a, and 24a. The projector 1 generates a single composite image stream using the I frames thus extracted. The projector 1 decodes the single composite image stream with a decoder 105 (see FIG. 2) to generate the image frame for each of the I frames.

The projector 1 projects a projection image 30 including images 31 through 34 corresponding to the respective image frames to a projection surface 3. The image 31 is an image corresponding to the image frame generated using the I frame received from the source 21. The image 32 is an image corresponding to the image frame generated using the I frame received from the source 22. The image 33 is an image corresponding to the image frame generated using the I frame received from the source 23. The image 34 is an image corresponding to the image frame generated using the I frame received from the source 24. The projection surface 3 is, for example, a screen or a wall.

FIG. 2 is a diagram schematically showing the projector 1. The projector 1 includes a receiving section 101, a communication section 102, a storage section 103, a processing section 104, the decoder 105, a display control section 106, and a projection section 107.

The receiving section 101 is, for example, a variety of operating buttons, operating keys, or a touch panel. The receiving section 101 receives the input operation of the user. The receiving section 101 can also be a remote controller for transmitting the information corresponding to the input operation wirelessly or with wire, or the like. In such a case, the projector 1 is provided with a receiver section for receiving the information transmitted by the remote controller. The remote controller is provided with a variety of operating buttons, operating keys, or a touch panel for receiving the input operation.

The communication section 102 wirelessly communicates with the sources 21 through 24. For example, the communication section 102 receives the image streams 21a, 22a, 23a, and 24a (see FIG. 1) with the UDP datagram.

In the header of the UDP datagram, there is described a transmission destination port number. The image streams 21a, 22a, 23a, and 24a are different in transmission destination port number from each other. Therefore, the transmission sources (the sources 21 through 24) of the image streams 21a, 22a, 23a, and 24a can be distinguished from each other using the transmission destination port numbers. Hereinafter, the transmission destination port numbers of the image streams 21a, 22a, 23a, and 24a are defined as “n1,” “n2,” “n3,” and “n4,” respectively.

Further, in the header of the UDP datagram, there is described the information (information representing either one of the I frame, the P frame, and the B frame) representing the type of the frame.

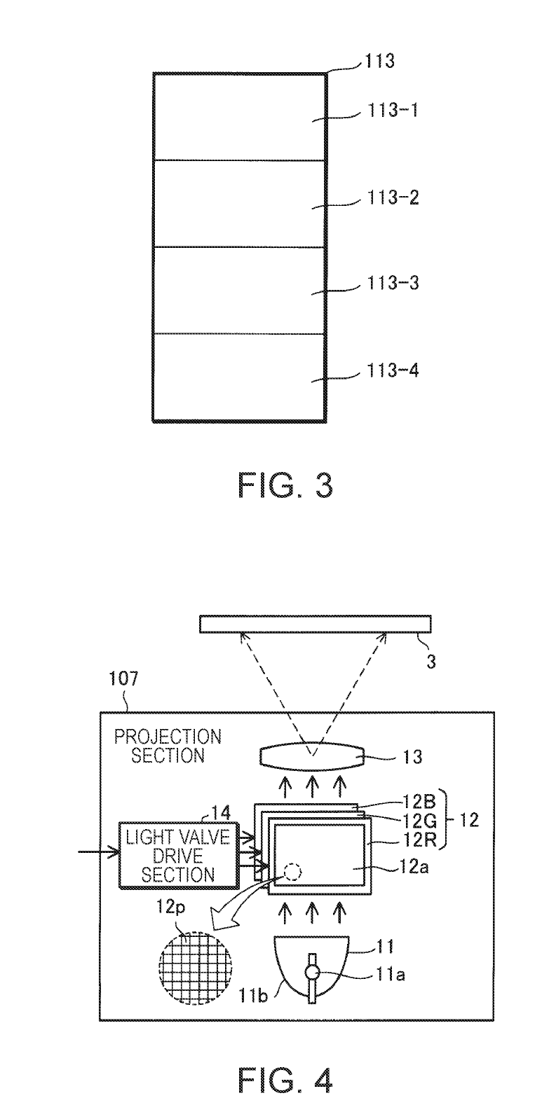

The storage section 103 is a computer-readable recording medium. The storage section 103 stores a program for defining the operation of the projector 1, and a variety of types of information. Further, the storage section 103 is provided with an image memory 113 shown in FIG. 3.

The image memory 113 has a buffer 113-1 corresponding to the transmission destination port number “n1,” a buffer 113-2 corresponding to the transmission destination port number “n2,” a buffer 113-3 corresponding to the transmission destination port number “n3,” and a buffer 113-4 corresponding to the transmission destination port number “n4.” Specifically, the buffer 113-1 corresponds to the source 21, the buffer 113-2 corresponds to the source 22, the buffer 113-3 corresponds to the source 23, and the buffer 113-4 corresponds to the source 24.

The description will be returned to FIG. 2. The processing section 104 is a computer such as a central processing unit (CPU). The processing section 104 retrieves and then performs the program stored in the storage section 103 to thereby realize an output destination switching section 108, a control section 109, an I frame extraction section 110, a PTS changing section 111, and a generation section 112.

The output destination switching section 108 switches the output destination of the image stream (the UDP datagram) received by the communication section 102 to either of the I frame extraction section 110 and the decoder 105 in accordance with an instruction of the control section 109.

Here, as the situation for the output destination switching section 108 to set the output destination of the image stream to the I frame extraction section 110, there can be cited a situation of projecting two or more thumbnails on the projection surface 3. As an example of the two or more thumbnails, there can be cited four thumbnails corresponding one-on-one to the image streams 21a, 22a, 23a, and 24a as shown in FIG. 1. It should be noted that the two or more thumbnails are not limited to the four thumbnails.

In contrast, as the situation for the output destination switching section 108 to set the output destination of the image stream to the decoder 105, there can be cited a situation of projecting an image corresponding to either one of the image streams 21a, 22a, 23a, and 24a on the projection surface 3.

The control section 109 controls the projector 1 in accordance with an input operation received by the receiving section 101. For example, the control section 109 controls the communication section 102 in accordance with the input operation to thereby control the communication with the sources 21 through 24. Further, the control section 109 controls the output destination switching section 108 in accordance with the input operation to thereby switch the output destination of the image stream from the output destination switching section 108.

The I frame extraction section 110 is an example of an extraction section. The I frame extraction section 110 extracts the I frame from each of the image streams 21a, 22a, 23a, and 24a received from the output destination switching section 108. Specifically, the I frame extraction section 110 extracts the I frame from the image stream 21a, extracts the I frame from the image stream 22a, extracts the I frame from the image stream 23a, and further extracts the I frame from the image stream 24a. It should be noted that the I frame extraction section 110 refers to the header of the UDP datagram of each of the image streams 21a, 22a, 23a, and 24a to identify the I frame.

The PTS changing section 111 is an example of an addition section. The PTS alternation section 111 changes the PTS appended to the I frame extracted by the I frame extraction section 110. For example, the PTS changing section 111 sets identification information corresponding to the transmission destination port number of the I frame having the PTS to the least significant digit of the numerical number with a plurality of digits represented by that PTS.

Furthermore, regarding the I frame extracted from the image stream 21a, the PTS changing section 111 sets the identification information corresponding to the transmission destination port number “n1” to the least significant digit of the numerical number with a plurality of digits represented by the PTS appended to the I frame.

Further, regarding the I frame extracted from the image stream 22a, the PTS changing section 111 sets the identification information corresponding to the transmission destination port number “n2” to the least significant digit of the numerical number with a plurality of digits represented by the PTS appended to the I frame.

Further, regarding the I frame extracted from the image stream 23a, the PTS changing section 111 sets the identification information corresponding to the transmission destination port number “n3” to the least significant digit of the numerical number with a plurality of digits represented by the PTS appended to the I frame.

Further, regarding the I frame extracted from the image stream 24a, the PTS changing section 111 sets the identification information corresponding to the transmission destination port number “n4” to the least significant digit of the numerical number with a plurality of digits represented by the PTS appended to the I frame.

The transmission destination port number corresponds to the image stream as the extraction source of the I frame, and at the same time corresponds also to the source having transmitted the image stream of the extraction source. Therefore, the identification information corresponding to the transmission destination port number “n1” is an example of first identification information corresponding to the transmission source of the image stream 21a. Further, the identification information corresponding to the transmission destination port number “n2” is an example of second identification information corresponding to the transmission source of the image stream 22a.

It should be noted that the buffers 113-1 through 113-4 shown in FIG. 3 correspond respectively to the transmission destination port numbers “n1” through “n4” on a one-to-one basis, and therefore, also correspond respectively to the identification information corresponding to the transmission destination port number on a one-to-one basis.

The generation section 112 generates the composite image stream using the I frames with the PTS changed. Specifically, the generation section 112 generates the composite image stream using the I frame extracted from the image stream 21a and having the PTS changed, the I frame extracted from the image stream 22a and having the PTS changed, the I frame extracted from the image stream 23a and having the PTS changed, and the I frame extracted from the image stream 24a and having the PTS changed.

The decoder 105 decodes the composite image stream to generate the image frame (the frame having been decoded) by the I frame (by the frame included in the composite image stream). The image frame has the PTS appended to the original I frame of the image frame. Therefore, in the image frames, the image frame (the first image frame) generated based on the I frame extracted from the image stream 21a has the identification information (the first identification information) corresponding to the transmission destination port number “n1.” Further, in the image frames, the image frame (the second image frame) generated based on the I frame extracted from the image stream 22a has the identification information (the second identification information) corresponding to the transmission destination port number “n2.”

The display control section 106 controls the display of the image corresponding to the image frame. The display control section 106 overwrites the image memory 113 with the image frame generated by the decoder 105 at the display timing represented by the PTS. On this occasion, the display control section 106 overwrites the buffer corresponding to the identification information set to the PTS with the image frame out of the buffers 113-1 through 113-4. Further, the display control section 106 generates an image signal corresponding to the projection image 30 including the images 31 through 34 (see FIG. 1) corresponding to the four image frames stored in the buffers 113-1 through 113-4.

The projection section 107 projects to display the image corresponding to the image frame on the projection surface 3. The projection section 107 is an example of a display section. The projection surface 3 is an example of a display surface. The projection section 107 as an example of the display section does not include the projection surface 3. The projection section 107 projects the projection image 30 corresponding to the image signal on the projection surface 3.

FIG. 4 is a diagram showing an example of the projection section 107. The projection section 107 includes a light source 11, three liquid crystal light valves 12 (12R, 12G, and 12B) as an example of a light modulating device, a projection lens 13 as an example of a projection optical system, a light valve drive section 14, and so on. The projection section 107 modulates the light emitted from the light source 11 with the liquid crystal light valves 12 to form the projection image (image light), and then projects the projection image from the projection lens 13 in an enlarged manner.

The light source 11 includes a light source section 11a formed of a xenon lamp, a super high-pressure mercury lamp, an LED (light emitting diode), a laser source, or the like, and a reflector 11b for reducing a variation in direction of the light emitted by the light source section 11a. The light emitted from the light source 11 is reduced in variation of the luminance distribution by an integrator optical system not shown, and is then separated by a color separation optical system not shown into colored light components of red (R), green (G), and blue (B) as three primary colors of light. The colored light components of R, G, and B respectively enter the liquid crystal light valves 12R, 12G, and 12B.

The liquid crystal light valves 12 are each formed of a liquid crystal panel having a liquid crystal material encapsulated between a pair of transparent substrates. The liquid crystal light valves 12 are each provided with a rectangular pixel area 12a composed of a plurality of pixels 12p arranged in a matrix, and arranged so that a drive voltage can be applied to the liquid crystal material for each of the pixels 12p. When the light valve drive section 14 applies the drive voltages corresponding to image signal input thereto from the display control section 106 to the respective pixels 12p, each of the pixels 12p is set to have a light transmittance corresponding to the image signal. Therefore, the light having been transmitted from the light source 11 is transmitted through the pixel area 12a to thereby be modulated, and thus, the image corresponding to the image signal is formed for each colored light.

The images of the respective colored light are combined by a color combining optical system not shown for each of the pixels 12p, and thus, the projection image as a color image (color image light) is generated. The projection image is projected by the projection lens 13 on the projection surface 3 in an enlarged manner.

Then, the operation will be described.

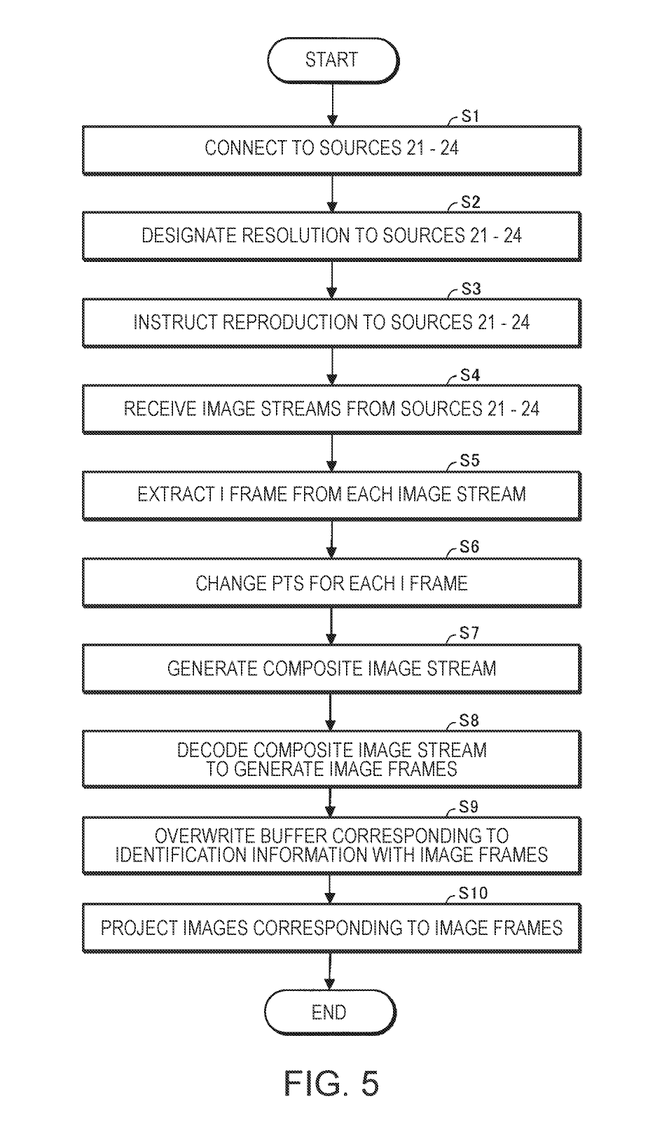

FIG. 5 is a flowchart for explaining the operation of the projector 1. Here, it is assumed that the output destination switching section 108 sets the output destination of the image stream to the I frame extraction section 110.

The projector 1 and the sources 21 through 24 are mutually found out by P2P (peer to peer) discovery as a device discovery procedure of Miracast, and are then connected to each other (step S1).

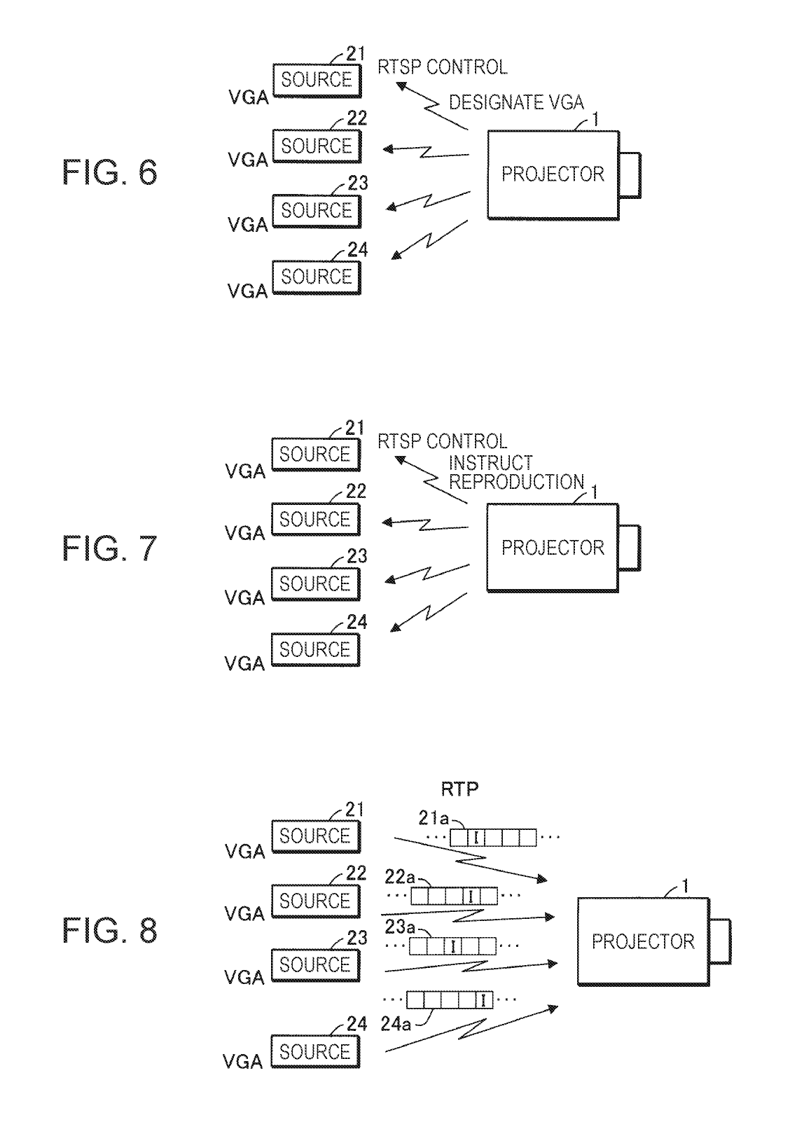

Subsequently, the projector 1 and the sources 21 through 24 exchange each other's information by the RTSP (real time streaming protocol). On this occasion, the communication section 102 of the projector 1 reports the information that only the lowest resolution of the requisite resolutions stipulated by Miracast, namely the VGA (video graphics array) resolution, is supported to the sources 21 through 24 as the equipment information of the projector 1 due to the control by the control section 109 (see FIG. 6). Reporting the equipment information by the communication section 102 to the sources 21 through 24 means (step S2) designation of the VGA resolution by the projector 1 (the communication section 102) to the sources 21 through 24. The VGA resolution is an example of a first resolution.

The sources 21 through 24 prepare for execution of the encode on the image frame of the VGA resolution in accordance with the equipment information. Subsequently, the sources 21 through 24 each await an instruction from the projector 1 in a state in which the image can be reproduced.

The control section 109 of the projector 1 outputs (step S3) the reproduction instructions to the sources 21 through 24 in sequence by the RTSP as shown in FIG. 7 using the communication section 102.

When receiving the reproduction instruction, each of the sources 21 through 24 starts the encode of the image frame of the VGA resolution to start generating the image stream.

Subsequently, each of the sources 21 through 24 starts transmitting the image stream to the projector 1 by the RTP (real time transport protocol) using the UDP datagram (see FIG. 8). Each of the sources 21 through 24 also describes the PCR to the UDP datagram to start the transmission.

In the projector 1, the communication section 102 starts (step S4) receiving the UDP datagram (the image stream and the PCR) from each of the sources 21 through 24. The output destination switching section 108 outputs the UDP datagram received by the communication section 102 to the I frame extraction section 110.

The I frame extraction section 110 refers to the header of the UDP datagram to extract (step S5) the I frame (the UDP datagram having the data of the I frame) for each of the image streams.

The I frame extraction section 110 continuously switches the image stream to be the extraction target by predetermined time (e.g., 3 seconds or 5 seconds). It should be noted that the predetermined time is not limited to 3 seconds or 5 seconds, but can properly be changed.

In the present embodiment, the I frame extraction section 110 continuously switches the image streams to be the extraction target circularly in the order of the image streams 21a, 22a, 23a, 24a, 21a, 22a, . . . . The I frame extraction section 110 can extract the plurality of I frames from the image stream to be the extraction target for a predetermined period of time, or can also extract just one I frame.

The I frame extraction section 110 outputs the I frame (the UDP datagram having the data of the I frame) thus extracted, and the PCRs (the UDP datagrams having the PCRs) from the respective sources 21 through 24 to the PTS changing section 111.

In the sources 21 through 24, the PCRs are independent of each other. The PTS of the I frame is set based on the PCR transmitted by the source as the transmission source of that I frame. In other words, the PTSs of the respective I frames different in transmission source from each other are set based on the respective PCRs different from each other.

Therefore, the PTS changing section 111 commonalizes the PCR used in each of the I frames, and changes the PTSs of the I frames in accordance with the commonalization of the PCRs. Further, the PTS changing section 111 sets (step S6) the identification information corresponding to the transmission source of each of the I frames to the PTS of that I frame.

Firstly, the commonalization of the PCRs and the change of the PTS corresponding to the commonalization of the PCRs will be described.

The PTS changing section 111 determines the PCR (hereinafter referred to as a “reference PCR”) from the PCRs transmitted from the sources 21 through 24. For example, the PTS changing section 111 determines the PCR having reached first the PTS changing section 111 as the “reference PCR” out of the plurality of PCRs. The reference PCR is used as a commonalized PCR.

Subsequently, the PTS changing section 111 calculates a time difference from the reference PCR for each of the PCRs different from the reference PCR. Subsequently, the PTS changing section 111 adds the time difference from the reference PCR in the PCR corresponding to the PTS to that PTS appended to the I frame. Due to the change of the PTS, it results that the PTS of each of the I frames is reset based on the reference PCR.

Then, setting of the identification information to the PTS will be described.

The PTS changing section 111 sets the identification information corresponding to the transmission destination port number of the I frame having the PTS to the least significant digit of the numerical number represented by that PTS.

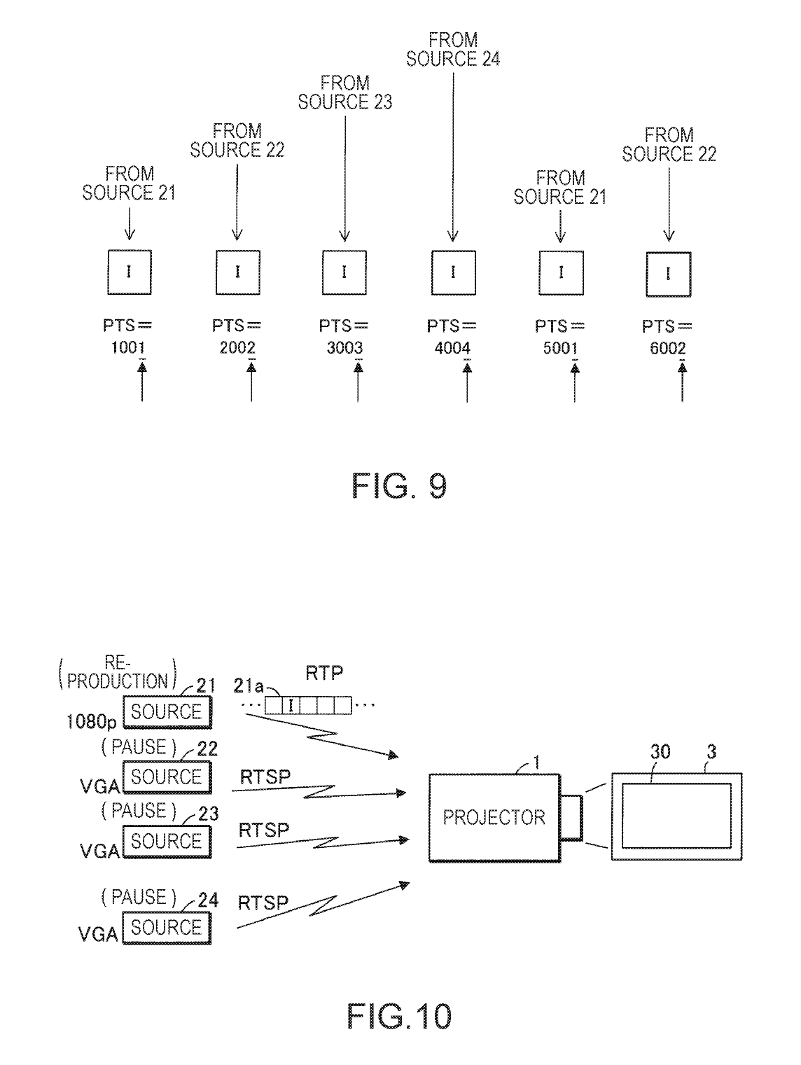

FIG. 9 is a diagram showing an example of setting identification information to the least significant digit of the PTS.

In the case in which the transmission destination port number of the I frame is “n1,” the PTS changing section 111 sets the value of the least significant digit of the PTS of that I frame to “1.” The value “1” is an example of the identification information corresponding to the transmission destination port number “n1.”

In the case in which the transmission destination port number of the I frame is “n2,” the PTS changing section 111 sets the value of the least significant digit of the PTS of that I frame to “2.” The value “2” is an example of the identification information corresponding to the transmission destination port number “n2.”

In the case in which the transmission destination port number of the I frame is “n3,” the PTS changing section 111 sets the value of the least significant digit of the PTS of that I frame to “3.” The value “3” is an example of the identification information corresponding to the transmission destination port number “n3.”

In the case in which the transmission destination port number of the I frame is “n4,” the PTS changing section 111 sets the value of the least significant digit of the PTS of that I frame to “4.” The value “4” is an example of the identification information corresponding to the transmission destination port number “n4.”

Subsequently, the generation section 112 arranges the I frames with the PTSs changed in the order of the display timings represented by the PTSs to thereby generate (step S7) the composite image stream. The generation section 112 outputs the composite image stream and the reference PCR to the decoder 105.

Subsequently, the decoder 105 decodes the composite image stream to generate (step S8) the image frame by I frame. The decoder 105 outputs the image frames and the reference PCR to the display control section 106.

Subsequently, the display control section 106 overwrites the image memory 113 with the image frame generated by the decoder 105 at the display timing represented by the PTS based on the reference PCR. On this occasion, the display control section 106 overwrites (step S9) the buffer corresponding to the identification information set to the PTS of the image frame with the image frame out of the buffers 113-1 through 113-4.

Subsequently, the display control section 106 generates the image signal corresponding to the projection image 30 (see FIG. 1) including the images 31 through 34 corresponding to the four image frames stored in the buffers 113-1 through 113-4. Subsequently, the projection section 107 projects (step S10) the images corresponding to the image signal on the projection surface 3.

Due to the projection, the image 31 based on the I frame from the source 21 is displayed as a thumbnail, and the images 32, 33, and 34 based on the I frames from the respective sources 22, 23, and 24 are displayed as thumbnails.

In the projection image 30, one of the four thumbnails is updated every time the predetermined period of time elapses. This update occurs due to the I frame extraction section 110 continuously switching the image stream to be the extraction target every predetermined period of time.

When the user operates the receiving section 101 to select either of the four thumbnails in the situation in which the projection image 30 is displayed, the control section 109 controls the communication section 102 and the output destination switching section 108 in accordance with the selection, and thus, the image corresponding to the thumbnail thus selected is projected on the projection surface 3.

Hereinafter, for the sake of simplification of the description, the description will be presented citing the case in which the image 31 (the image corresponding to the I frame from the source 21) has been selected as an example.

Firstly, the control section 109 controls the communication section 102 to cut the connection to the source 21 once by the RTSP, and then achieve reconnection to the source 21. Subsequently, the control section 109 controls the communication section 102 to transmit the information representing the resolution (e.g., 1080 p) which the projector 1 can deal with as the equipment information of the projector 1 to the source 21 by the RTSP, and then transmit the reproduction instruction to the source 21. The resolution of 1080 p is an example of a second resolution.

When the source 21 receives the equipment information, and then further receives the reproduction instruction, the source 21 starts transmitting the image stream obtained by encoding the image frames with the resolution of, for example, 1080 p to the projector 1 using the UDP datagram.

In the case in which the resolution of the image reproduced by the source 21 can be changed in the state in which the projector 1 is connected to the source 21, it is not necessary to once cut the connection between the projector 1 and the source 21.

The control section 109 controls the communication section 102 to transmit a pause instruction to each of the sources 22 through 24 by the RTSP before the communication section 102 transmits the reproduction instruction to the source 21. Therefore, even if an amount of data of the image stream to be transmitted by the source 21 increases due to the change in resolution, it is possible to prevent the image stream from becoming hard to reach the projector 1 (see FIG. 10).

Further, the control section 109 issues an instruction to the output destination switching section 108 to switch the output destination of the output destination switching section 108 from the I frame extraction section 110 to the decoder 105. Therefore, the decoder 105 decodes the image stream to be transmitted by the source 21 to generate the image frames for each of the frames included in the image stream. The display control section 106 generates an image signal for showing the image corresponding to the image frame generated by the decoder 105 in the entire screen, and the projection section 107 projects the image corresponding to this image signal on the projection surface 3. In this case, since the sources 22 through 24 are each in a pause, the projection section 107 projects neither the image corresponding to the image stream 22a, the image corresponding to the image stream 23a, nor the image corresponding to the image stream 24a.

According to the projector 1 and the method of controlling the projector 1 of the present embodiment, the images provided by the plurality of sources 21 through 24 of Miracast can be displayed as the thumbnails while updating these images. Then, when one of these thumbnails is selected, an image corresponding to the thumbnail thus selected is displayed on the entire screen. Therefore, it is possible to provide a measure for intuitively selecting the source for providing the image to be displayed on the entire screen.

For example, in the case in which a measure using the MAC (media access control) address or the device name of the source is used as the measure for selecting the source for providing the image to be displayed on the entire screen, since the MAC address and the device name do not intuitively link with the source, the usability becomes worse. Further, in this case, there occur work for confirming the relationship between the MAC address or the device name, and the source in advance, and work for typing the MAC address or the device name.

According to the present embodiment, it becomes possible to resolve the deterioration of the usability and the work occurring in the case of using the MAC address or the device name.

Further, by generating the single image stream (the composite image stream) synthesized only from the I frames, it is possible to decode the plurality of image streams received in parallel with each other with a single decoder without requiring a plurality of decoders. Therefore, a simple and low-price system configuration can be realized.

Further, when decoding the frame having belonged to a certain image stream, the frames having belonged to other image streams can be inhibited from being referred to, and therefore, it becomes possible to suppress the deterioration of the image due to the decoding.

Further, by superimposing the identification information as the information for identifying the source on the PTS, there is an advantage that it is not necessary to modify or correct the decoder 105 in order to handle the identification information.

It should be noted that in the case of an image combined with a sound, if the PTS of the image is changed, there is a possibility that there occurs a synchronization shift between the sound and the image. However, by inhibiting the output of the sound in the case of performing the thumbnail display, it becomes possible to prevent the synchronization shift from occurring.

Further, since in the composite image stream, the image is updated only by the I frame while the PTSs are regularly arranged in the order of the display timings, it is possible to perform a stable update with little disturbance in the image.

### Second Embodiment

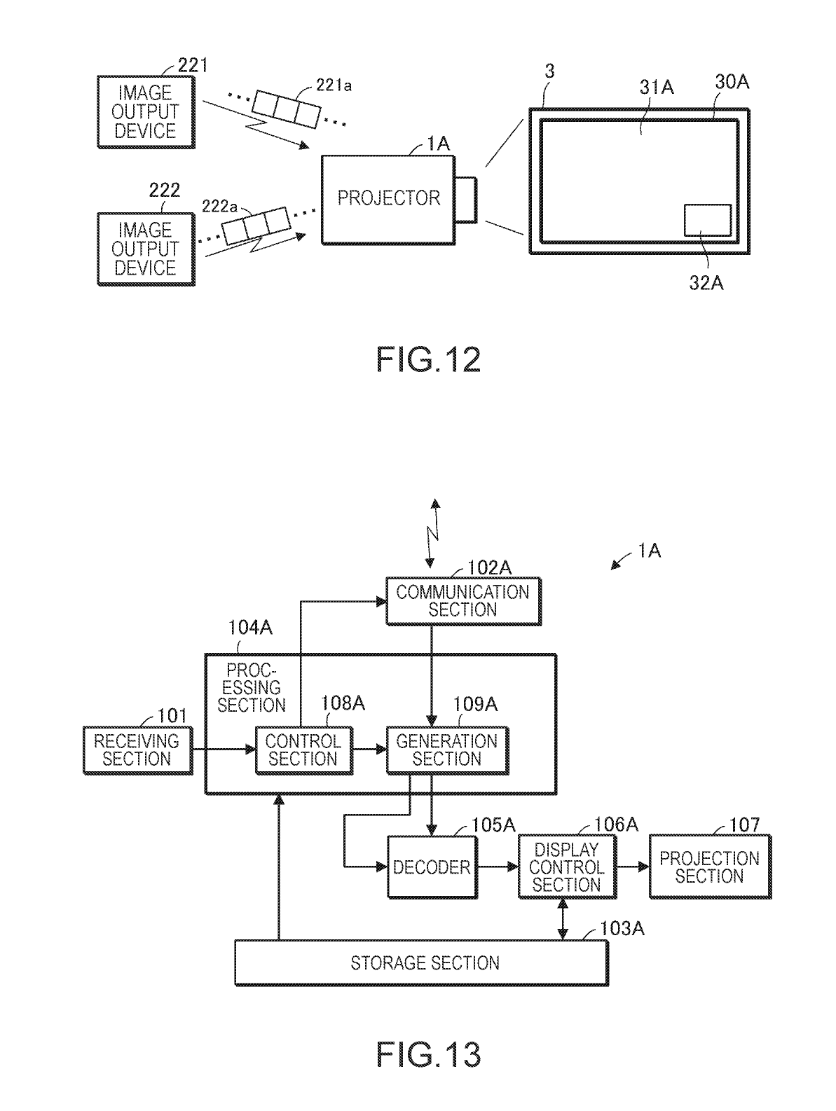

FIG. 12 is a diagram showing a projector 1A related to a display device according to a second embodiment to which the invention is applied. The projector 1A has the sink function of Miracast. The projector 1A achieves concurrent connection with a plurality of image output devices 221 through 222 each having the source function of Miracast with wireless communication. It should be noted that the number of the image output devices with which the projector 1 achieves the concurrent connection is not limited to 2, and is only required to be equal to or larger than 2.

The image output devices 221 through 222 are each, for example, a smartphone or a tablet terminal. It should be noted that the image output devices 221 through 222 are not limited to the smartphones or the tablet terminals, and are only required to be the equipment having the source function of Miracast. For example, as the image output devices, there are used the sources of Miracast.

The image output devices 221 through 222 each wirelessly transmit an image stream (a moving image) formed of a plurality of coded frames to the projector 1A with the UDP datagram. Further, the image output devices 221 through 222 each wirelessly transmit the PCR, which is time information to be the reference of decode timing and display (reproduction) timing, to the projector 1A.

Hereinafter, the image stream transmitted by the image output device 221 is also referred to as an “image stream 221a.” The image stream transmitted by the image output device 222 is also referred to as an “image stream 222a.” The image stream 221a is an example of the first image stream. The image stream 222a is an example of the second image stream.

The image stream can include three types of frames, namely the I frame, the P frame, and the B frame.

The I frame, the P frame, and the B frame each have the PTS. The PTS represents the display timing of the frame with reference to the PCR with a value of a numerical number with a plurality of digits. The larger the numerical value represented by the PTS is, the later the display timing becomes. The PTS is an example of the timing information.

Further, the I frame, the P frame, and the B frame each have a DTS (decoding time stamp). The DTS represents the decode timing of the frame with reference to the PCR with a value of a numerical number with a plurality of digits.

The projector 1A receives the image streams 221a and 222a in parallel with each other. The projector 1A generates a composite image stream using the image streams 221a and 222a. The composite image stream is an example of a third image stream.

The projector 1A decodes the frames included in the composite image stream with a single decoder 105A (see FIG. 13) at the timing based on the PCR and the DTS to generate the image frames by the frame included in the composite image stream.

In the case in which the projector 1A generates the composite image stream using, for example, a part (the I frame) of the image stream 222a, and the image stream 221a, the projector 1A performs the decoding of the frames located anterior to the part of the image stream 222a at a second frame rate higher than a first frame rate specified by the image stream 221a in the composite image stream.

Here, the first frame rate depends on the time intervals of the decoding of the frames constituting the image stream 221a, and the time intervals are specified by the DTSs of the respective frames of the image stream 221a. Therefore, the first frame rate is specified based on the image stream 221a, more specifically, based on the DTSs of the respective frames of the image stream 221a.

Then, the projector 1A decodes a part of the image stream 222a and so on with the single decoder 105A using the idle time created by raising the decoding frame rate from the first frame rate to the second frame rate.

The projector 1A generates the image corresponding to the image frame generated from the image stream 221a at the timing based on the PCR and the PTS of the image stream 221a, and generates the image corresponding to the image frame generated from the image stream 222a at the timing based on the PCR and the PTS of the image stream 222a.

The projector 1A projects a projection image 30A including the image corresponding to the image frame generated from the image stream 221a, and the image corresponding to the image frame generated from the image stream 222a on the projection surface 3.

For example, in the case in which the projector 1A generates the composite image stream using the part of the image stream 222a, and the image stream 221a, the projector 1A projects the projection image 30A in which an image 32A corresponding to the image frame generated from the part of the image stream 222a is located on an image 31A corresponding to the image frame generated from the image stream 221a on the projection surface 3.

FIG. 13 is a diagram schematically showing the projector 1A. The projector 1A includes the receiving section 101, a communication section 102A, a storage section 103A, a processing section 104A, the decoder 105A, a display control section 106A, and the projection section 107.

The communication section 102A wirelessly communicates with the image output devices 221 and 222. For example, the communication section 102A receives the image streams 221a and 222a (see FIG. 12) with the UDP datagram.

In the header of the UDP datagram, there is described a transmission destination port number. The image streams 221a and 222a are different in transmission destination port number from each other. Therefore, the transmission sources (the image output devices 221 and 222) of the image streams 221a and 222a can be distinguished from each other using the transmission destination port numbers. Hereinafter, the transmission destination port number of the image stream 221a is defined as “n1a,” and the transmission destination port number of the image stream 222a is defined as “n2a.”

Further, in the header of the UDP datagram, there is described the information (information representing either one of the I frame, the P frame, and the B frame) representing the type of the frame.

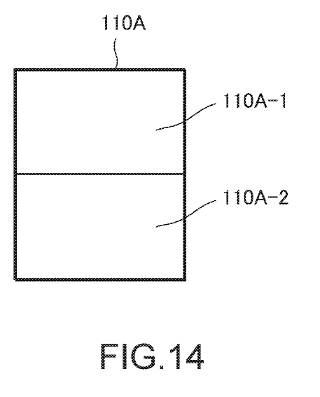

The storage section 103A is a computer-readable recording medium. The storage section 103A stores a program for defining the operation of the projector 1A, and a variety of types of information. Further, the storage section 103A is provided with an image memory 110A shown in FIG. 14. The image memory 110A has a buffer 110A-1 and a buffer 110A-2.

The description will be returned to FIG. 13. The processing section 104A is a computer such as a CPU. The processing section 104A retrieves and then executes the program stored in the storage section 103A to thereby realize the control section 108A and the generation section 109A.

The control section 108A controls the projector 1A in accordance with an input operation received by the receiving section 101. For example, the control section 108A controls the communication section 102A in accordance with the input operation to thereby control the communication with the image output devices 221 and 222.

The generation section 109A generates a composite image stream using the image stream 221a and the image stream 222a. In the present embodiment, the generation section 109A switches whether to generate the composite image stream using a part (the I frame) of the image stream 222a and the image stream 221a, or using a part (the I frame) of the image stream 221a and the image stream 222a in accordance with an instruction from the control section 108A.

For the sake of simplification of the description, there will hereinafter be described the case in which the generation section 109A generates the composite image stream using the I frame of the image stream 222a and the image stream 221a. In this case, the image stream 221a becomes an “insertion destination image stream,” and the image stream 222a becomes an “insertion source image stream.”

Further, the generation section 109A controls the DTSs and the PTSs of the frames included in the composite image stream. The generation section 109A controls the DTSs to thereby control the frame rate (the frame rate in the decoding) in the decoder 105A.

Further, the generation section 109A sets the identification information corresponding to the transmission destination port number of the second frame to the PTS of the I frame (the second frame) of the image stream 222a included in the composite image stream. The transmission destination port number also corresponds to the image output device having transmitted the second frame.

Setting the identification information corresponding to the transmission destination port number to the PTS of the second frame is an example of appending the identification information corresponding to the transmission source of the second frame to the second frame.

The decoder 105A decodes the composite image stream to generate the image frame (the frame having been decoded) by the frame included in the composite image stream. Specifically, the decoder 105A decodes the frames at the timings represented by the DTSs of the frames by the frame included in the composite image stream to generate the image frames. It should be noted that the image frames each have the PTS appended to the original frame of the image frame.

The display control section 106A controls the display of the image corresponding to the image frame. The display control section 106A overwrites the image memory 110A with the image frame generated by the decoder 105A at the display timing represented by the PTS.

On this occasion, the display control section 106A overwrites the buffer 110A-1 with the image frame having the PTS to which the identification information has not been set, and overwrites the buffer 110A-2 with the image frame having the PTS to which the identification information has been set.

Further, the display control section 106A generates an image signal corresponding to the projection image 30A including the images 31A and 32A (see FIG. 12) using the two image frames stored in the buffers 110A-1 and 110A-2.

The projection section 107 projects the projection image 30A corresponding to the image signal on the projection surface 3.

Then, the operation will be described.

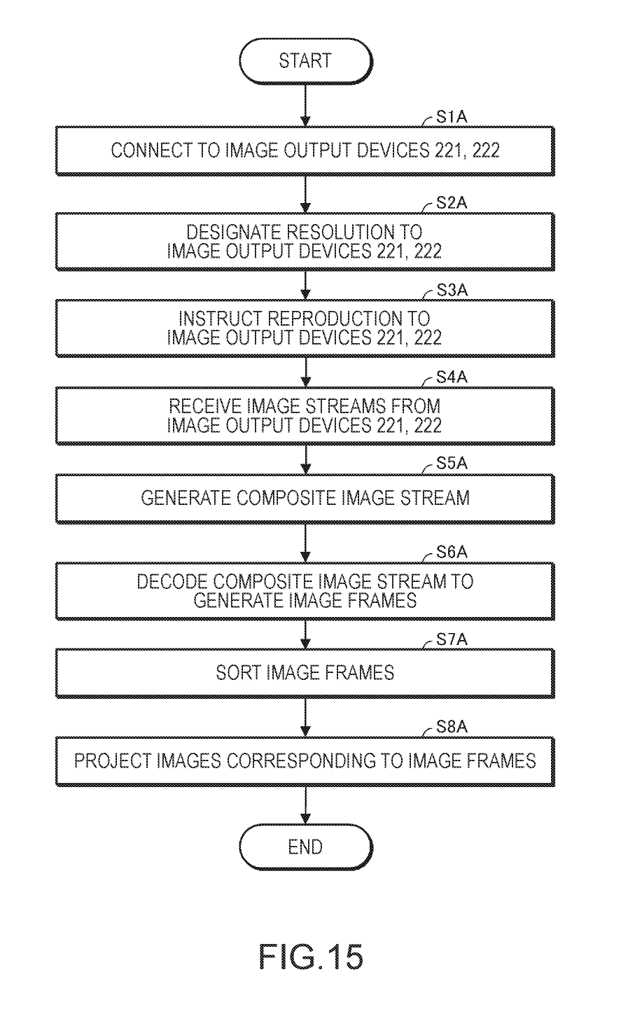

FIG. 15 is a flowchart for explaining the operation of the projector 1A.

The projector 1A and the image output devices 221 and 222 are mutually found out by the P2P discovery as the device discovery procedure of Miracast, and are then connected to each other (step S1A).

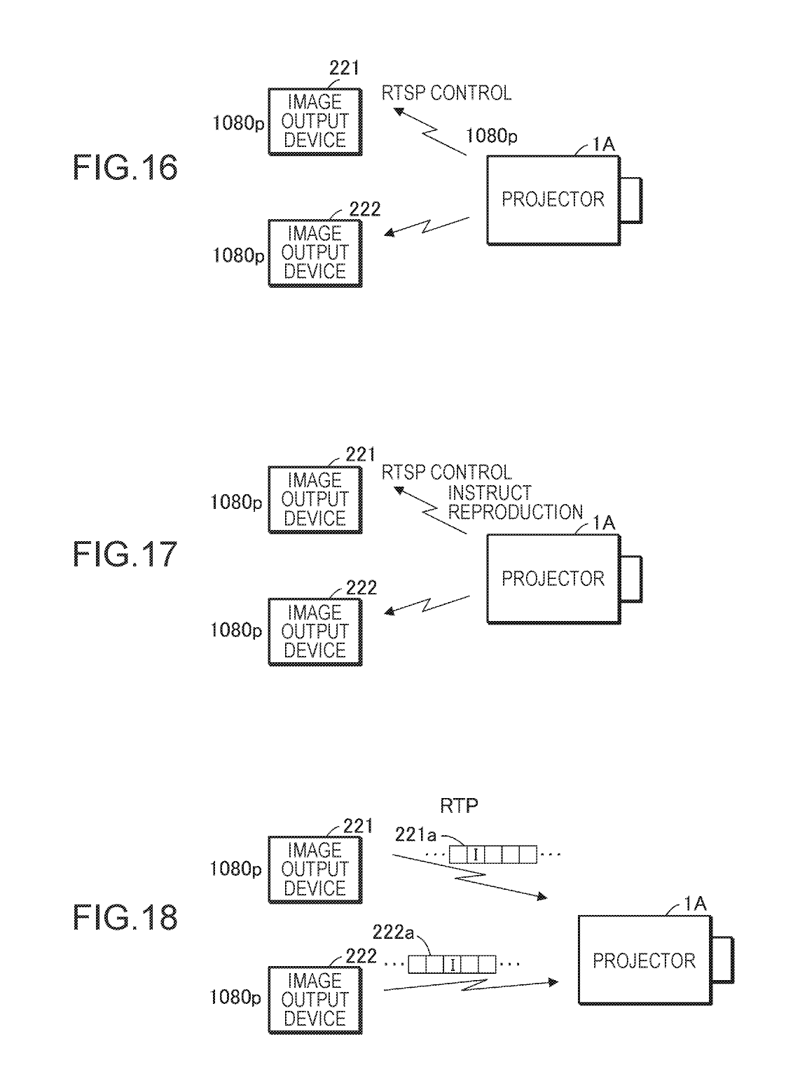

Subsequently, the projector 1A and the image output devices 221 and 222 exchange each other's information by the RTSP. On this occasion, the communication section 102A of the projector 1A reports the highest resolution (e.g., 1080 p) which the projector 1A can deal with to the image output devices 221 and 222 as the equipment information of the projector 1A due to the control by the control section 108A (see FIG. 16). Reporting the equipment information by the communication section 102A to the image output devices 221 and 222 means (step S2A) designation of the resolution by the projector 1A (the communication section 102A) to the image output devices 221 and 222.

The image output devices 221 and 222 prepare for execution of the encoding on the image frame of the resolution represented by the equipment information. Subsequently, the image output devices 221 and 222 each await an instruction from the projector 1A in a state in which the image can be reproduced.

The control section 108A of the projector 1A outputs (step S3A) the reproduction instructions to the image output devices 221 and 222 in sequence by the RTSP as shown in FIG. 17 using the communication section 102A.

When receiving the reproduction instruction, each of the image output devices 221 and 222 starts the encoding of the image frame of the resolution represented by the equipment information to start generating the image stream.

Subsequently, each of the image output devices 221 and 222 starts transmitting the image stream to the projector 1A by the RTP using the UDP datagram (see FIG. 18). Each of the image output devices 221 and 222 also describes the PCR to the UDP datagram to start the transmission.

In the projector 1A, the communication section 102A starts (step S4A) receiving the UDP datagram (the image stream 221a, the image stream 222a, and the PCR) from each of the image output devices 221 and 222.

It should be noted that it is also possible for the control section 108A to receive the UDP datagram (the image stream 221a) from the image output device 221 preferentially to the UDP datagram (the image stream 222a) from the image output device 222. For example, it is possible for the control section 108A to make the time used for receiving the UDP datagram from the image output device 221 longer than the time used for receiving the UDP datagram from the image output device 222. The communication section 102A outputs the UDP datagram to the generation section 109A.

The generation section 109A generates (step S5A) the composite image stream using the UDP datagram (the image stream 221a) from the image output device 221 and the UDP datagram (the image stream 222a) from the image output device 222. The step S5A is an example of a generation step.

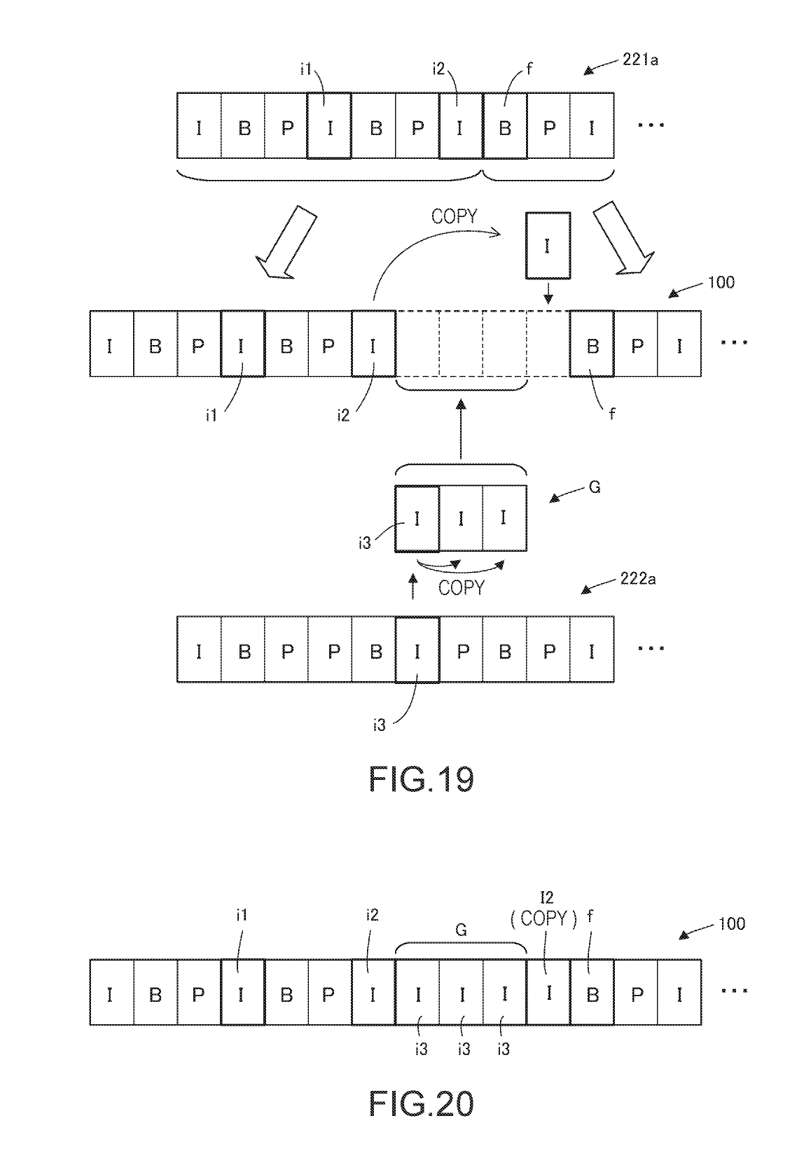

FIG. 19 is a diagram for describing a method for generating a composite image stream 100.

The generation section 109A firstly refers to the transmission destination port number described in the header of the UDP datagram to distinguish the image stream 221a and the image stream 222a from each other.

Subsequently, the generation section 109A analyzes (analyzes, for example, the header of the UDP datagram) the image stream 222a to extract the I frame i3 from the image stream 222a. The I frame i3 is an example of the second frame.

The generation section 109A extracts the I frame i3 from the image stream 222a, and then identifies two I frames i1 and i2 from the image stream 221a. The I frame i1 is located previous to the I frame i2. The I frame i2 is an example of the first frame.

Subsequently, the generation section 109A calculates a total amount m obtained by totalizing the number of the I frame i1, the number of the I frame i2, and the number of the frames existing between the I frame i1 and the I frame i2. In the example shown in FIG. 19, the total amount m is “4.”

Subsequently, the generation section 109A copies the I frame i3 “m−2” times. Subsequently, the generation section 109A generates a frame group G having “m−1” I frames i3 successively disposed using the “m−2” copies of the I frame i3 and the I frame i3.

Subsequently, the generation section 109A inserts the frame group G immediately after the I frame i2. In other words, the generation section 109A inserts the frame group G between the I frame i2 and a frame f located immediately after the I frame i2 in the image stream 221a. The frame f is an example of a third frame.

Subsequently, the generation section 109A generates a copy of the I frame i2. Subsequently, the generation section 109A inserts the copy of the I frame i2 between the frame group G and the frame f. In other words, the generation section 109A inserts the copy of the I frame i2 immediately before the frame f.

FIG. 20 is a diagram showing an example of the composite image stream 100.

As shown in FIG. 20 and FIG. 19, the composite image stream 100 becomes larger in the number of frames than the image stream 221a as much as the total of the number of the copy of the I frame i2 and the number of “m−1” I frames i3. Therefore, there becomes necessary additional time (hereinafter also referred to as “additional decode time”) for the decoder 105A to decode the copy of the I frame i2 and the “m−1” I frames i3.

Therefore, the generation section 109A controls the frame rate of the decoder 105A so that the additional decode time is worked out, and at the same time, the copy of the I frame i2 and the “m−1” I frames i3 are decoded within the additional decode time. Specifically, the generation section 109A controls the DTS of the composite image stream 100 and the operating frequency of the decoder 105A.

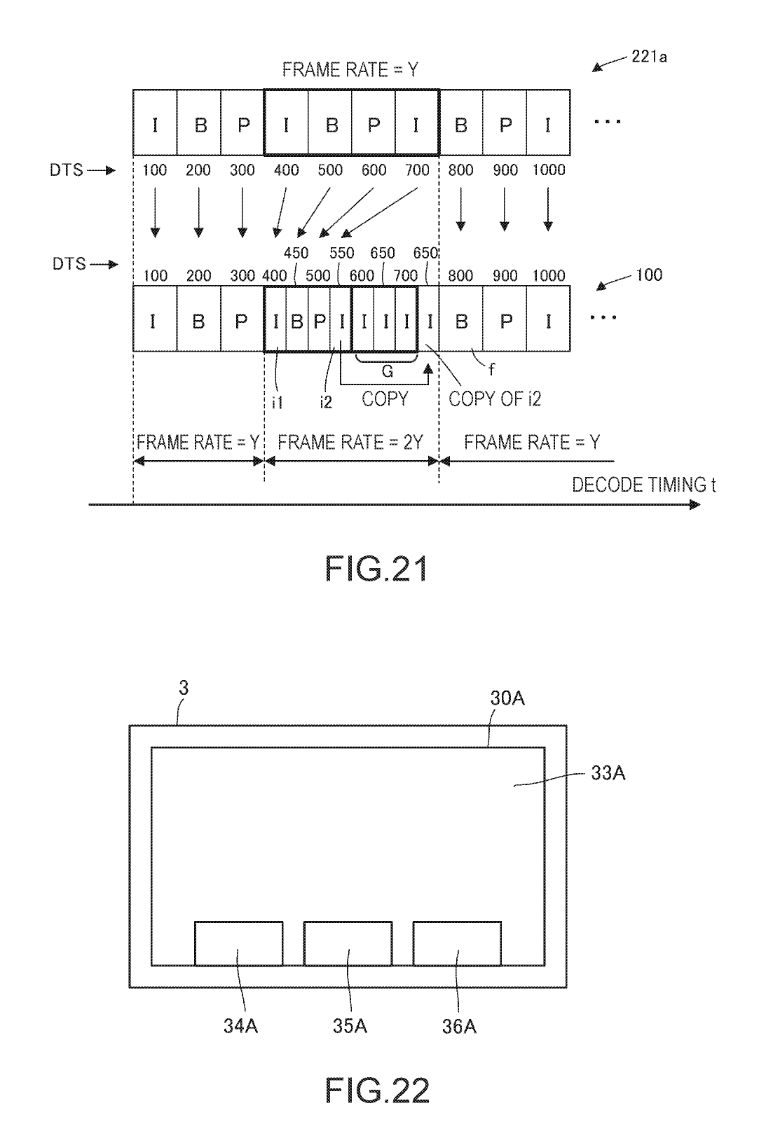

FIG. 21 is a diagram for explaining the control of the DTS of the composite image stream 100. In FIG. 21, the image stream 221a is also shown as a comparative example. In the image stream 221a, it is assumed that the difference in DTS between the frames temporally adjacent to each other is set to “100” in order to achieve simplification of the explanation. Further, the decoding frame rate in the case in which the difference in DTS between frames temporally adjacent to each other is “100” is represented by “Y.”

Here, since the composite image stream 100 has the B frame, the frames in the composite image stream 100 are decoded in an order different from the alignment sequence in the composite image stream 100 in some cases. Therefore, in reality, in the case of arranging the frames in the composite image stream 100 in the order of the decoding, the difference in DTS between the frames temporally adjacent to each other becomes “100.”

It should be noted that the difference in DTS between the frames temporally adjacent to each other is not limited to “100,” but can arbitrarily be changed.

The generation section 109A controls the DTS of the frames (hereinafter referred to as “DTS control target frame”) from the frame immediately after the I frame i1 to the copy of the I frame i2 so that the decoding frame rate from the I frame i1 to the copy of the I frame i2 becomes “2Y” in the composite image stream 100.

Specifically, the generation section 109A controls the DTSs of the DTS control target frames so that the difference in DTS between the DTS control target frames temporally adjacent to each other becomes “50” a half as large as “100.” In other words, since the number of the frames increases as much as 4 in the composite image stream 100 compared to the image stream 221a, the generation section 109A makes the decoding frame rate of the 8 frames twice as high as Y.

Here, in the composite image frame 100, the frames from the I frame i1 to the I frame i2 are an example of one or more frames previous to the second frame. The frame rate Y is an example of a first frame rate. The frame rate 2Y is an example of a second frame rate.

Subsequently, the generation section 109A sets the identification information (e.g., a specific numerical number) corresponding to the transmission destination port number of the I frame i2 to a specific digit (e.g., the most significant digit) of the PTS of the I frame i2 included in the composite image stream 100. Subsequently, the generation section 109A outputs the composite image stream 100 to the decoder 105A.

Further, the generation section 109A also outputs the PCRs to the decoder 105A.

In the image output devices 221 and 222, the PCRs are independent of each other. The DTS and the PTS of the frame included in the composite image stream 100 are set based on the PCR transmitted by the image output device as the transmission source of that frame. In other words, the DTSs and the PTSs of the respective frames different in transmission source from each other are set based on the respective PCRs different from each other.

Therefore, the generation section 109A determines the PCR (the PCR transmitted from the image output device 221) corresponding to the image stream 221a to be the insertion destination in the composite image stream 100 as the PCR (hereinafter referred to as a “reference PCR”) to be the reference.

The generation section 109A also outputs the reference PCR to the decoder 105A.

Further, the generation section 109A retrieves the DTS of the I frame i1 and the DTS of the frame f from the composite image stream 100 to store the DTSs in an internal memory not shown. Then, the generation section 109A switches the operating frequency of the decoder 105A to a frequency twice as high as the previous operating frequency of the decoder 105A at the timing represented by the DTS of the I frame i1 of the composite image stream 100. Further, the generation section 109A switches the operating frequency of the decoder 105A to a frequency a half as high as the previous operating frequency of the decoder 105A at the timing represented by the DTS of the frame f of the composite image stream 100.

The decoder 105A decodes the frames at the timings represented by the DTSs of the frames, and based on the reference PCR by the frame included in the composite image stream 100 to generate the image frames (step S6A). The step S6A is an example of a decode step.

Therefore, the decoder 105A decodes the copy of the I frame i2 and the frame group G within the time of the difference between the decode time in the case of decoding the I frame i1 through the I frame i2 of the composite image stream 100 at the frame rate Y and the decode time in the case of decoding the I frame i1 through the I frame i2 of the composite image stream 100 at the frame rate 2Y (see FIG. 21).

It should be noted that the image frames are each provided with the PTS appended to the original frame of the image frame.

The decoder 105A outputs the image frames provided with the PTSs and the reference PCR to the display control section 106A.

The display control section 106A sorts (step S7A) the image frames in accordance with whether or not the identification information has been set to the PTS.

Specifically, the display control section 106A overwrites the buffer 110A-1 of the image memory 110A with the image frame (the image frame corresponding to the image stream 221a) having the PTS to which the identification information has not been set out of the image frames at the display timing (the display timing based on the reference PCR) represented by the PTS. It should be noted that it is also possible for the display control section 106A to delete the image frame generated based on the copy of the I frame i2.

In contrast, regarding the image frame (the image frame corresponding to the image stream 222a) having the PTS to which the identification information has been set out of the image frames generated by the decoder 105A, the display control section 106A overwrites the buffer 110A-2 of the image memory 110A with that image frame in the case in which the display control section 106A has found that image frame irrespective of the PTS.

Subsequently, the display control section 106A generates an image signal corresponding to the projection image 30A (see FIG. 12) including the images 31A and 32A using the two image frames stored in the buffers 110A-1 and 110A-2.

In the present embodiment, the display control section 106A generates the image signal corresponding to the projection image 30A in which the image 32A corresponding to the image frame stored in the buffer 110A-2 is located on the image 31A corresponding to the image frame stored in the buffer 110A-1. Subsequently, the projection section 107 projects (step S8A) the images corresponding to the image signal on the projection surface 3. The step S8A is an example of a control step.

Due to the projection, the image 31A based on the image stream 221a from the image output device 221 is displayed, and the image 32A based on the I frame from the image output device 222 is displayed as a thumbnail.

When the user operates the receiving section 101 to select the image 32A in the situation in which the projection image 30A is displayed, the projector 1A switches the “insertion destination image stream” from the image stream 221a to the image stream 222a, and switches the “insertion source image stream” from the image stream 222a to the image stream 221a, and then performs the operation described above. On this occasion, the connection between the projector 1A and the image output devices 221, 222 is continued.

According to the projector 1A and the method of controlling the projector 1A related to the present embodiment, the projector 1A decodes some frames of the image stream 222a with the decoder 105A using the time which is made idle by increasing the decoding frame rate of some frames of the image stream 221a from the frame rate Y to the frame rate 2Y. Therefore, it becomes possible to prevent the number of the decoders 105A from increasing in the configuration of displaying the plurality of images based on the plurality of image streams. Further, even in the case of the configuration of using a single decoder 105A, it becomes possible to display at least the outline of the image represented by each of the plurality of image streams 221a and 222a having been received in parallel with each other.

Further, in the composite image stream 100, the frames of the image stream 221a temporally adjacent to the I frame i3 are made as the I frames. Therefore it becomes possible to perform the decoding of the frame (e.g., the P frame or the B frame) having belonged to the image stream 221a using only the frames having belonged to the image stream 221a in the decoding of the composite image stream 100. Therefore, it is possible to inhibit the frames having belonged to the image stream 222a from being referred to when decoding the frames having belonged to the image stream 221a.

Further, by superimposing the identification information as the information for identifying the image output device on the PTS of the I frame i2, there is an advantage that it is not necessary to modify or correct the decoder 105A in order to handle the identification information.

Further, in the image frames generated by decoding the insertion destination image stream (e.g., the image stream 221a), the PTS is maintained. Therefore, in the case in which the insertion destination image stream is combined with a sound stream, it becomes possible to maintain the synchronization between the image and the sound.

It should be noted that in the case in which the insertion source image stream (e.g., the image stream 222a) is combined with the sound stream, there is a possibility that there occurs a synchronization shift between the sound and the image. However, by inhibiting the output of the sound in the case of performing the thumbnail display, it becomes possible to prevent the synchronization shift from occurring.

### Modified Examples

The invention is not limited to the embodiments described above, but can variously be modified as described below, for example. Further, it is also possible to appropriately combine one or more modifications arbitrarily selected from the configurations of the modifications described below.

### Modified Example 1

In the first embodiment, it is also possible for the PTS changing section 111 to set the identification information to a specific digit different from the most significant digit of the PTS (e.g., a plurality of digits including the least significant digit of the PTS without including the most significant digit of the PTS).

### Modified Example 2

In the first embodiment, it is sufficient for the image streams used for generating the composite image stream to be at least two of the image streams transmitted from a plurality of sources connected to the projector 1. The at least two image streams correspond to another example of the plurality of image streams.

### Modified Example 3

Although in each of the embodiments, transmission by the RTP is performed using the UDP, it is also possible to perform the transmission using a TCP (transmission control protocol) instead of the UDP in the case in which there is room in the communication band, and the capacity of the processing section 104 (104A) of the projector 1 (1A) to be the sink is sufficient. It should be noted that the case of using the UDP is not provided with retransmission control, and is therefore superior in real-time performance, and is useful in the thumbnail usage.

### Modified Example 4

Although in the first embodiment, there is described the configuration in which the thumbnails are displayed as a list, it is also possible to perform the display of switching the thumbnails in sequence in a single display area using the fact that the image corresponding to the composite image stream is a single moving image for replacing the thumbnails every predetermined time.

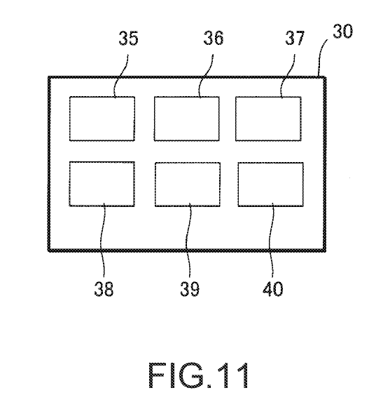

FIG. 11 is a diagram for describing an example of the display in which the thumbnails are switched in sequence in a single display area. The projection image 30 to be the home screen is provided with image display areas 35 through 40. The moving image (the moving image in which the thumbnails are switched every predetermined time) corresponding to the composite image stream is displayed in either one (e.g., the image display area 40) of the image display areas 35 through 40. In this case, it is sufficient for the image memory 113 to have one buffer for the composite image stream. It should be noted that in the image display areas 35 through 39, there are displayed other moving images or still images.

### Modified Example 5

In the first embodiment, when displaying the thumbnails, the resolution is fixed to the VGA resolution, which is the lowest resolution of the requisite resolutions stipulated by Miracast.

However, in the case in which there is room in the communication band between the projector 1 and the sources 21 through 24 and the processing capacity of the decoder 105, and further the decoder 105 can reproduce the I frames even if the I frames different in resolution continue, it is possible to operate the decoder 105 without fixing the resolution of the image to the lowest resolution. It should be noted that in this case, there occurs the situation in which the image frames having been decoded are different in resolution from each other, and therefore, it becomes difficult to deal with Modified Example 4. Therefore, it is desirable to uniform the resolutions of the images to be reproduced by the sources 21 through 24.

### Modified Example 6

In the first embodiment, it is possible to additionally perform the RTSP control of repeating the reproduction and the pause periodically for each image stream in order to reduce the burden of the communication band. On this occasion, in the case of attempting to take the thumbnail image, it is sufficient to perform reproduction in advance, and then perform the pause after taking the thumbnail image from the projector 1 on the sources 21 through 24 due to the RTSP control to thereby intermittently transmit the RTP stream.

### Modified Example 7

The communication between the projector 1 and the sources 21 through 24, and the communication between the projector 1A and the image output devices 221 and 222 are not limited to Miracast, but can properly be changed. For example, in Miracast, the P2P device discovery is used for finding out the source, but it is also possible to use a different method from the P2P device discovery such as mDNS (multicast domain name system) for finding out the source. Further, as the protocol for designating the resolution to the source, and then controlling the reproduction of the source, there can be used DLNA (digital living network alliance) or the like instead of Miracast.

### Modified Example 8

In the first embodiment, the PTS changing section 111 adds the time difference from the reference PCR in the corresponding PCR to the PTS to thereby make the PTS correspond to the reference PCR. However, it is also possible for the PTS changing section 111 to update all of the PTSs based on the reference PCR.

### Modified Example 9

In the first embodiment, the first resolution is not limited to the VGA resolution, but can properly be changed. Further, the second resolution is not limited to the resolution of 1080 p, but is only required to be a resolution different from the first resolution.

### Modified Example 10

Some or all of the elements realized by at least one of the processing sections 104 and 104A executing the program can also be realized by hardware using an electronic circuit such as a FPGA (field programmable gate array) or an ASIC (application specific IC), or can also be realized by a cooperative operation of software and hardware.

### Modified Example 11

In each of the embodiments, in the projection section 107, the liquid crystal light valves are used as the light modulating device, but the light modulating device is not limited to the liquid crystal light valves, and can properly be changed. For example, it is also possible to adopt a configuration using three reflective liquid crystal panels as the light modulating device. Further, it is also possible for the light modulating device to have a configuration such as a method using a single liquid crystal panel, a method using three digital mirror devices (DMD), or a method using a single digital mirror device. In the case of using just one liquid crystal panel or DMD as the light modulating device, the members corresponding to the color separation optical system and the color combining optical system are unnecessary. Further, besides the liquid crystal panel or the DMD, any configurations capable of modulating the light emitted by the light source can be adopted as the light modulating device.

### Modified Example 12

As the display device, there is used the projector 1 or 1A for displaying the image on the projection surface 3, but the display device is not limited to the projector 1 or 1A, and can properly be changed. For example, the display device can also be a direct-view display (e.g., a liquid crystal display, an organic EL (electroluminescence) display, a plasma display, or a CRT (cathode ray tube) display). In this case, a direct-view display section is used instead of the projection section 107. It should be noted that in the case in which the projector 1 or 1A is used as the display device, the projection surface 3 is not included in the display device.

### Modified Example 13

In the second embodiment, the second frame rate is not limited to the rate twice as high as the first frame rate, but is only required to be higher than the first frame rate. In this case, the higher the second frame rate is, the larger the number of the I frames i3 included in the frame group G can be made. It should be noted that even if the second frame rate increases, the number of the I frames i3 included in the frame group G can be kept constant.

The number of the I frames i3 included in the frame group G can also be, for example, “1.” In the case of setting the number of the I frames i3 included in the frame group G to “1” in the example shown in FIG. 21, it is also possible to set the decoding frame rate of the I frames i3 included in the frame group G, and the copy of the I frame i2 to the first frame rate.

Further, the frames to be decoded at the second frame rate out of the frames previous to the frame group G at the decode timing are not required to include the frame immediately before the frame group G.

### Modified Example 14

In the second embodiment, the configuration of the image stream 221a is not limited to the configuration shown in FIG. 19, but can properly be changed. Further, the configuration of the image stream 222a is not limited to the configuration shown in FIG. 19, but can properly be changed.

### Modified Example 15

It is also possible for the generation section 109A to set the identification information to a specific digit (e.g., a digit including the least significant digit of the PTS without including the most significant digit of the PTS) different from the most significant digit of the PTS.

### Modified Example 16

In the case in which the projector 1A receives the image streams from three or more image output devices in parallel with each other, it is also possible for the generation section 109A to treat either one of the image streams as the insertion destination image stream, and treat the rest of the image streams as the insertion source image streams.

In this case, the generation section 109A generates the frame group G with the I frames extracted from the insertion source image streams. Then, the generation section 109A sets the identification information corresponding to the insertion source image streams to the PTSs of the I frames constituting the frame group G.

In addition, the display control section 106A writes the image corresponding to the image frame having been decoded into the areas corresponding to the identification information set to the PTS of that image frame in the projection image 30A.

FIG. 22 is a diagram showing an example of the projection image 30A in the case in which the projector 1A receives the image streams respectively from four image output devices in parallel with each other.

In the area 33A, there is displayed the image corresponding to the insertion destination image stream, and in the areas 34A through 36A, there are displayed the images corresponding respectively to the insertion source image streams one by one as the thumbnails.

### Modified Example 17

There is described the example using the PCR, the PTS, and the DTS of the MPEG2-system as timestamp information, but other timestamps can also be used.

### Modified Example 18

In the first embodiment shown in FIG. 1, a communication device can exist between the plurality of sources and the projector. This communication device receives the image streams from the plurality of sources, then combines the image streams to generate a single composite image stream, and then transmits the single composite image stream to the projector.

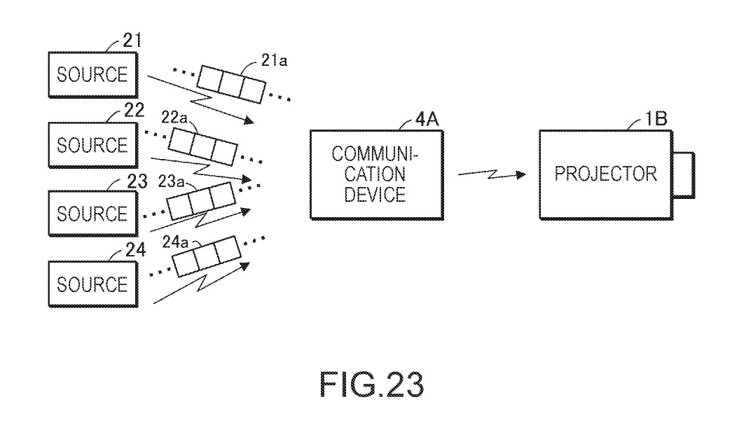

FIG. 23 is a diagram showing an example of a projector system in which the communication device exists between the plurality of sources and the projector. In FIG. 23, those having the same configurations as those shown in FIG. 1 are denoted by the same reference symbols.

In FIG. 23, the projector system includes the sources 21 through 24, the communication device 4A, and the projector 1B.

The communication device 4A receives the image streams 21a, 22a, 23a, and 24a in parallel with each other. The communication device 4A extracts the I frame from each of the image streams 21a, 22a, 23a, and 24a. The communication device 4A generates a single composite image stream using the I frames thus extracted. The communication device 4A transmits the single composite image stream to the projector 1B.

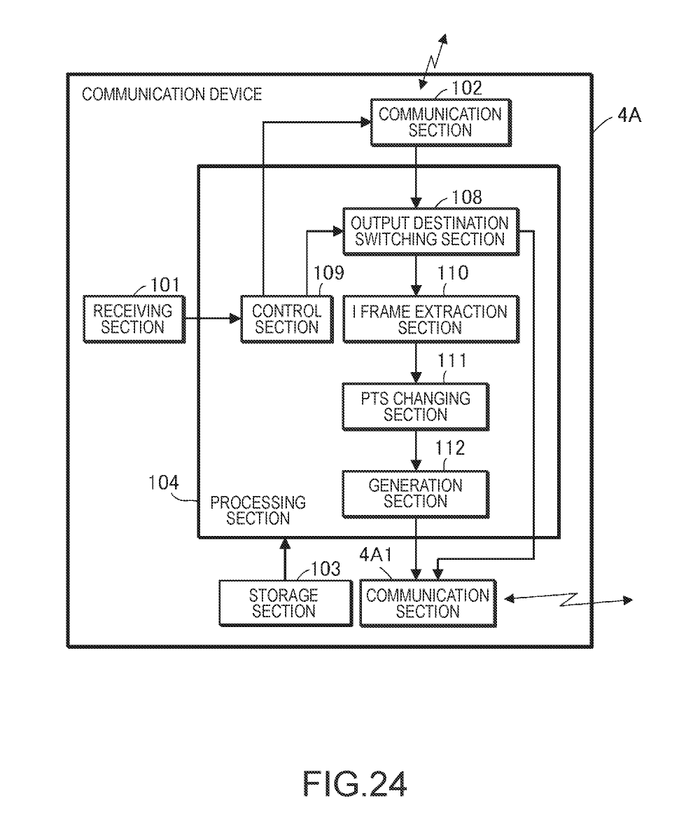

FIG. 24 is a diagram schematically showing the communication device 4A. In FIG. 24, those having the same configurations as those shown in FIG. 2 are denoted by the same reference symbols. Hereinafter, the description will be presented with a focus on the constituents different from the constituents shown in FIG. 2 out of the constituents shown in FIG. 24.

The communication device 4A includes the receiving section 101, the communication section 102, the storage section 103, the processing section 104, and a communication section 4A1. The processing section 104 retrieves and then performs the program stored in the storage section 103 to thereby realize the output destination switching section 108, the control section 109, the I frame extraction section 110, the PTS changing section 111, and the generation section 112.

In the present modified example, the output destination switching section 108 switches the output destination of the image stream (the UDP datagram) received by the communication section 102 to either of the I frame extraction section 110 and the communication section 4A1 in accordance with an instruction of the control section 109. As the situation for the output destination switching section 108 to set the output destination of the image stream to the communication section 4A1, there can be cited a situation of outputting either one of the image streams 21a, 22a, 23a, and 24a to the communication section 4A1.

The communication section 4A1 transmits the single composite image stream generated by the generation section 112 to the projector 1B. Further, the communication section 4A1 transmits the image stream output by the output destination switching section 108 to the projector 1B.

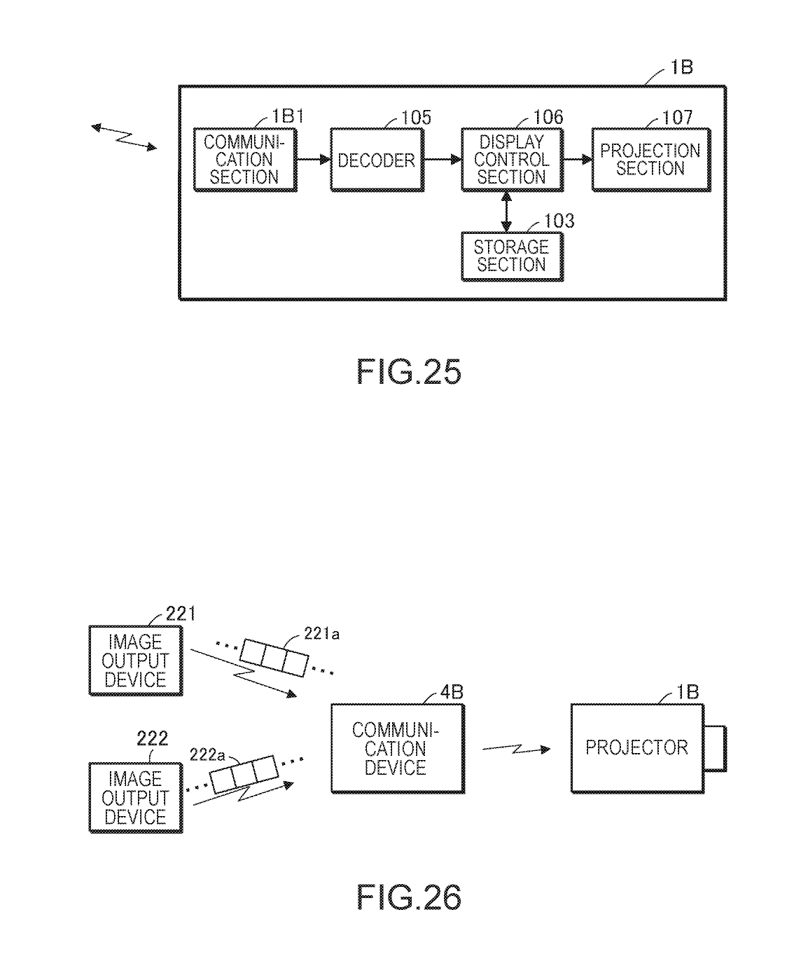

FIG. 25 is a diagram schematically showing the projector 1B. In FIG. 25, those having the same configurations as those shown in FIG. 2 are denoted by the same reference symbols. Hereinafter, the description will be presented with a focus on the constituents different from the constituents shown in FIG. 2 out of the constituents shown in FIG. 25.

The projector 1B includes a communication section 1B1, the storage section 103, the decoder 105, the display control section 106, and the projection section 107.

The communication section 1B1 receives the single composite image stream transmitted from the communication section 4A. Further, the communication section 1B1 receives the image stream transmitted from the communication device 4A. The decoder 105 decodes the single composite image stream received by the communication section 1B1. Further, the decoder 105 decodes the image stream received by the communication section 1B1.

In the present modified example, the communication device 4A generates the single composite image stream obtained by combining only the I frames from the plurality of image streams, and then transmits the single composite image stream to the projector 1B. The projector 1B receives the single composite image stream transmitted from the communication device 4A, and then decodes the composite image stream with the single decoder 105 to generate the image frames. Therefore, it is possible for the projector 1B to decode the plurality of image streams with the single decoder without requiring a plurality of decoders. Therefore, a simple and low-price system configuration can be realized.

### Modified Example 19

In the second embodiment shown in FIG. 12, a communication device can exist between the plurality of image output devices and the projector.

FIG. 26 is a diagram showing an example of a projector system in which the communication device exists between the plurality of image output devices and the projector. In FIG. 26, those having the same configurations as those shown in FIG. 12 or FIG. 23 are denoted by the same reference symbols.

In FIG. 26, the projector system includes the image output devices 221 and 222, the communication device 4B, and the projector 1B.

The communication device 4B receives the image streams 221a and 222a in parallel with each other. The communication device 4B generates a composite image stream using the image streams 221a and 222a. Regarding the composite image stream, the communication device 4B also generates an instruction (hereinafter also referred to as a “decode instruction”) related to the decoding of the composite image stream. The communication device 4B transmits the composite image stream and the decode instruction to the projector 1B. The projector 1B receives the composite image stream and the decode instruction to decode the composite image stream in accordance with the decode instruction.

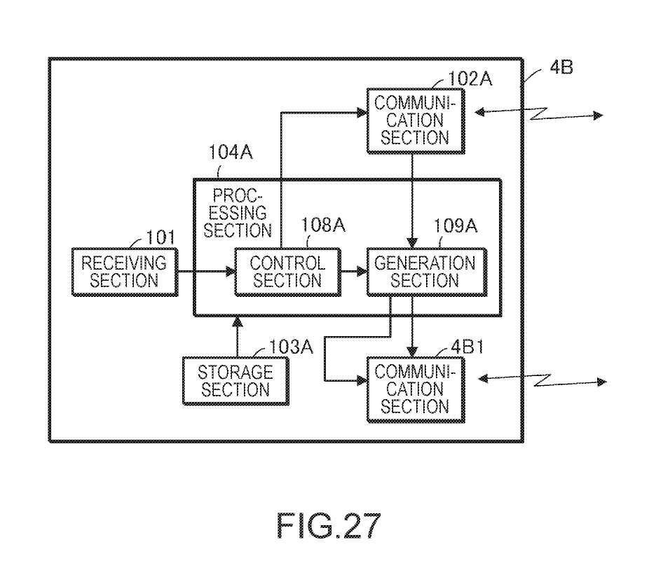

FIG. 27 is a diagram schematically showing the communication device 4B. In FIG. 27, those having the same configurations as those shown in FIG. 13 are denoted by the same reference symbols. Hereinafter, the description will be presented with a focus on the constituents different from the constituents shown in FIG. 3 out of the constituents shown in FIG. 27.

The communication device 4B includes the receiving section 101, the communication section 102A, the storage section 103A, the processing section 104A, and a communication section 4B1. The processing section 104A retrieves and then executes the program stored in the storage section 103A to thereby realize the control section 108A and the generation section 109A.

In the present modified example, the generation section 109A generates an instruction for controlling the operating frequency of the decoder (the decoder 105 of the projector 1B in the present modified example) for decoding the composite image stream as the decode instruction. The content of the decode instruction is substantially the same as the content of the control of the decode of the decoder 105A by the generation section 109A in the second embodiment.

The decode instruction includes a first instruction and a second instruction. For example, in the case of generating the composite image stream 100 shown in FIG. 20 by the composite image stream, the generation section 109A generates the first instruction and the second instruction described below.

The first instruction is an instruction of switching the operating frequency of the decoder 105 to a frequency twice as high as the previous frequency of the decoder 105 at the timing represented by the DTS of the I frame i1 of the composite image stream 100. Here, the first instruction is an example of the instruction of performing the decode of one or more frames previous to the second frame in the third image stream at the second frame rate higher than the first frame rate specified in the first image stream.

The second instruction is an instruction of switching the operating frequency of the decoder 105 to a frequency a half as high as the previous frequency of the decoder 105 at the timing represented by the DTS of the frame f of the composite image stream 100. Here, the second instruction is an example of the instruction for decoding the copy of the first frame and the second frame within the time of the difference between the decode time in the case of decoding one or more frames at the first frame rate and the decode time in the case of decoding one or more frames at the second frame rate.

The communication section 4B1 transmits the composite image stream and the decode instruction to the projector 1B.

In the projector 1B, when the communication section 1B1 receives the composite image stream and the decode instruction from the communication device 4B, the decoder 105 decodes the image stream in accordance with the decode instruction.

In the present modified example, the communication device 4B makes the projector 1A decode some frames of the image stream 222a with the decoder 105 using the time which is made idle by increasing the decoding frame rate of some frames of the image stream 221a from the frame rate Y to the frame rate 2Y. Therefore, it is possible for the projector 1B to decode the plurality of image streams with the single decoder without requiring a plurality of decoders. Therefore, a simple and low-price system configuration can be realized.

What is claimed is:

1. A display device comprising:
an extraction section adapted to extract a first reference frame coded by intra-frame compression from a first image stream, and extract a second reference frame coded by the intra-frame compression from a second image stream;
a generation section adapted to generate a composite image stream using the first reference frame and the second reference frame;
a decoder adapted to decode the composite image stream to generate image frames by a frame included in the composite image stream; and
a display section adapted to display an image corresponding to the image frame on a display surface.

2. The display device according to claim 1, further comprising:
a communication section adapted to receive the first image stream and the second image stream; and
an addition section adapted to append first identification information corresponding to a transmission source of the first image stream to the first reference frame, and append second identification information corresponding to a transmission source of the second image stream to the second reference frame,
wherein in the image frames, a first image frame generated based on the first reference frame has the first identification information,
in the image frames, a second image frame generated based on the second reference frame has the second identification information, and
the display section displays an image corresponding to the first image frame in a display area corresponding to the first identification information, and displays an image corresponding to the second image frame in a display area corresponding to the second identification information.

3. The display device according to claim 2, wherein
the first reference frame and the second reference frame have timing information representing a display timing with a value of a numerical number with a plurality of digits,
the larger the value of the numerical number is, the later the display timing becomes, and
the addition section sets the first identification information to a specific digit different from a most significant digit out of the plurality of digits of the timing information the first reference frame has, and sets the second identification information to the specific digit out of the plurality of digits of the timing information the second reference frame has.

4. The display device according to claim 3, wherein
the specific digit includes a least significant digit without including a most significant digit out of the plurality of digits.

5. The display device according to claim 2, wherein
the communication section further designates resolution of an image stream to a transmission source of the first image stream and a transmission source of the second image stream.

6. The display device according to claim 5, wherein
in a case in which the display section displays the image corresponding to the first image frame and the image corresponding to the second image frame, the communication section designates first resolution to a transmission source of the first image stream and a transmission source of the second image stream, and in a case in which the display section displays the image corresponding to the first image frame without displaying the image corresponding to the second image frame, the communication section designates second resolution different from the first resolution to the transmission source of the first image stream.

7. A method of controlling a display device, comprising:
extracting a first reference frame coded by intra-frame compression from a first image stream;
extracting a second reference frame coded by the intra-frame compression from a second image stream;
generating a composite image stream using the first reference frame and the second reference frame;
decoding the composite image stream to generate image frames by a frame included in the composite image stream; and
displaying an image corresponding to the image frame on a display surface.

8. A display device comprising:
a generation section adapted to generate a third image stream using a first image stream having a first frame coded by intra-frame compression, and a second image stream having a second frame coded by the intra-frame compression;
a decoder adapted to decode the third image stream to generate image frames by a frame included in the third image stream; and
a display control section adapted to control display of an image corresponding to the image frame,
wherein the third image stream is an image stream obtained by inserting the second frame between the first frame and a third frame subsequent to the first frame, and further inserting a copy of the first frame previous to the third frame in the first image stream, and
the decoder decodes
at least one frame previous to the second frame in the third image stream at a second frame rate higher than a first frame rate specified in the first image stream, and
the copy of the first frame and the second frame within a difference in time between decode time in a case of decoding at least one frame at the first frame rate and decode time in a case of decoding at least one frame at the second frame rate.

9. The display device according to claim 8, further comprising:
a communication section adapted to receive the first image stream and the second image stream,
wherein the generation section appends identification information corresponding to a transmission source of the second frame to the second frame,
the image frame generated based on the second frame has the identification information, and
the display control section displays an image corresponding to the image frame having the identification information in a different area from an area of an image corresponding to the image frame not having the identification information.

10. The display device according to claim 9, wherein
the image frame generated based on the second frame has timing information representing a display timing with a value of a numerical number with a plurality of digits,
the larger the value of the numerical number is, the later the display timing becomes, and
the generation section sets the identification information to a specific digit out of the plurality of digits.

11. A method of controlling a display device, comprising:
generating a third image stream using a first image stream having a first frame coded by intra-frame compression,
and a second image stream having a second frame coded by the intra-frame compression;
decoding the third image stream to generate image frames by a frame included in the third image stream; and
controlling display of an image corresponding to the image frame,
wherein the third image stream is an image stream obtained by inserting the second frame between the first frame and a third frame subsequent to the first frame, and further inserting a copy of the first frame previous to the third frame in the first image stream, and
in the decoding the third image stream,
at least one frame previous to the second frame in the third image stream is decoded at a second frame rate higher than a first frame rate specified in the first image stream, and
the copy of the first frame and the second frame are decoded within a difference in time between decode time in a case of decoding at least one frame at the first frame rate and decode time in a case of decoding at least one frame at the second frame rate.

12. A communication device comprising:
an extraction section adapted to extract a first reference frame coded by intra-frame compression from a first image stream, and extract a second reference frame coded by the intra-frame compression from a second image stream;
a generation section adapted to generate a composite image stream using the first reference frame and the second reference frame; and
a communication section adapted to transmit the composite image stream to a display device.

13. A method of controlling a communication device, comprising:
extracting a first reference frame coded by intra-frame compression from a first image stream;
extracting a second reference frame coded by the intra-frame compression from a second image stream;
generating a composite image stream using the first reference frame and the second reference frame; and
transmitting the composite image stream to a display device.

14. A communication device comprising:
a generation section adapted to generate a third image stream using a first image stream having a first frame coded by intra-frame compression, and a second image stream having a second frame coded by the intra-frame compression; and
a communication section adapted to transmit the third image stream and an instruction related to decoding of the third image stream to a display device,
wherein the third image stream is an image stream obtained by inserting the second frame between the first frame and a third frame subsequent to the first frame, and further inserting a copy of the first frame previous to the third frame in the first image stream, and
the instruction instructs to decode
at least one frame previous to the second frame in the third image stream at a second frame rate higher than a first frame rate specified in the first image stream, and
the copy of the first frame and the second frame within a difference in time between decode time in a case of decoding at least one frame at the first frame rate and decode time in a case of decoding at least one frame at the second frame rate.

15. A method of controlling a communication device, comprising:
generating a third image stream using a first image stream having a first frame coded by intra-frame compression, and a second image stream having a second frame coded by the intra-frame compression; and
transmitting the third image stream and an instruction related to decoding of the third image stream to a display device,
wherein the third image stream is an image stream obtained by inserting the second frame between the first frame and a third frame subsequent to the first frame, and further inserting a copy of the first frame previous to the third frame in the first image stream, and
the instruction instructs to decode
at least one frame previous to the second frame in the third image stream at a second frame rate higher than a first frame rate specified in the first image stream, and
the copy of the first frame and the second frame within a difference in time between decode time in a case of decoding at least one frame at the first frame rate and decode time in a case of decoding at least one frame at the second frame rate.
